(19) United States
(12) Patent Application Publication
(10) Pub. No.: US 2023/0288830 A1
(43) Pub. Date: Sep. 14, 2023

(54) METHOD FOR PRODUCING CARRIER FOR DEVELOPING ELECTROSTATIC CHARGE IMAGE, ELECTROSTATIC CHARGE IMAGE DEVELOPER, IMAGE FORMING METHOD, AND IMAGE FORMING APPARATUS

(71) Applicant: FUJIFILM Business Innovation Corp., Tokyo (JP)

(72) Inventors: Takeshi TANABE, Kanagawa (JP); Shintaro Anno, Kanagawa (JP); Yasuo Kadokura, Kanagawa (JP)

(73) Assignee: FUJIFILM Business Innovation Corp., Tokyo (JP)

(21) Appl. No.: 18/161,835

(22) Filed: Jan. 30, 2023

(30) Foreign Application Priority Data
Mar. 8, 2022 (JP) 2022-035226

(51) Int. Cl. G03G 9/113; G03G 9/107

(52) U.S. Cl. CPC G03G 9/1131; G03G 9/107

(57) ABSTRACT

A method for producing a carrier for developing an electrostatic charge image, the method includes: adding a coating liquid containing a resin, conductive particles, and a solvent and magnetic particles to a mixer having a stirring blade, and mixing the coating liquid and the magnetic particles to obtain a mixture; and evaporating and drying the solvent from the mixture to produce a carrier having a resin coating layer on surfaces of the magnetic particles, wherein a viscosity μ of the coating liquid when being added to the mixer is more than 60 mPa·s and 1,000 mPa·s or less, and a value of a ratio μ/W of the viscosity μ(mPa·s) to an amount W (parts by mass) of the resin coating layer with respect to 100 parts by mass of the magnetic particles in the carrier is 20 or more and 500 or less.

### CROSS-REFERENCE TO RELATED APPLICATIONS

This application is based on and claims priority under 35 USC 119 from Japanese Patent Application No. 2022-035226 filed Mar. 8, 2022.

### BACKGROUND OF THE INVENTION

### (i) Technical Field

The present invention relates to a method for producing a carrier for developing an electrostatic charge image, an electrostatic charge image developer, an image forming method, and an image forming apparatus.

### (ii) Related Art

JP1993-181321A discloses a color developer containing at least a color toner having non-magnetic colorant-containing resin particles and an external additive and a carrier, in which (1) the toner contains titanium oxide fine particles having a particle size in the range of 0.01 to 0.2 μm and a hydrophobicity of 40% to 80% as the external additive, and (2) the carrier is a carrier coated with 0.05 to 10.0% by weight of a resin with respect to the weight of the core material of the carrier and having a weight-average particle size in the range of 17 to 200 μm, the carrier is a carrier whose core material is coated with a resin having a number-average molecular weight (Mn) in the range of 10,000 to 200,000 and a glass transition temperature (Tg) of 55° C. to 140° C., and the carrier is a carrier coated with a resin using a resin solution having a viscosity at the time of being injected into a resin coating device of 6 to 60 cP as a coating resin under conditions of a temperature in the device of 60° C. to 140° C.

JP1998-97104A discloses an electrophotographic carrier having a resin coating film layer containing a thermosetting resin as a main component on the entire surface of carrier particles, wherein a convex resin film portion is formed as a thin film, and the occupancy rate of the convex resin film is 55% to 90% of the entire area of the carrier.

### SUMMARY

Aspects of non-limiting embodiments of the present disclosure relate to a method for producing a carrier for developing an electrostatic charge image, which is excellent in suppressing color dullness of an image to be obtained, as compared with a case in which the viscosity μ of the coating liquid when being added to a mixer is 60 mPa·s or less or more than 1,000 mPa·s, or the value of the ratio μ/W of the viscosity μ(mPa·s) to the amount W (parts by mass) of the resin coating layer with respect to 100 parts by mass of the magnetic particles in the carrier is less than 20 or more than 500.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for producing a carrier for developing an electrostatic charge image, the method comprising: mixing in a mixer a coating liquid that contains a resin, conductive particles, and a solvent, and magnetic particles to obtains a mixture thereof, the mixer having a stirring blade; and drying the solvent from the mixture by evaporation in order to produce a carrier having a resin coating layer on surfaces of the magnetic particles, wherein a viscosity μ of the coating liquid when being added to the mixer is more than 60 mPa·s and 1,000 mPa·s or less, and a value of a ratio/W of the viscosity μ(mPa·s) to an amount W (parts by mass) of the resin coating layer with respect to 100 parts by mass of the magnetic particles in the carrier is 20 or more and 500 or less.

### BRIEF DESCRIPTION OF THE DRAWINGS

FIG. 1 is a schematic diagram illustrating an example of an image forming apparatus according to an exemplary embodiment.

FIG. 2 is a schematic diagram illustrating an example of a process cartridge detachably attached to an image forming apparatus according to an exemplary embodiment.

FIG. 3 shows a schematic graph showing a fluctuation of load power value of a stirring blade and a fluctuation of temperature inside a mixer with time in an example of a method for producing a carrier for developing an electrostatic charge image according to an exemplary embodiment.

### DETAILED DESCRIPTION

Hereinafter, exemplary embodiments of the present disclosure will be described. These descriptions and examples exemplify the exemplary embodiments, and do not limit the scope of the exemplary embodiments.

In the present disclosure, a numerical range indicated by using “to” indicates a range including numerical values before and after “to” as a minimum value and a maximum value, respectively.

In numerical ranges described in a stepwise manner in the present disclosure, an upper limit value or a lower limit value described in a certain numerical range may be replaced with an upper limit value or a lower limit value of another numerical range in the stepwise description. In addition, in a numerical range described in the present disclosure, the upper limit value or the lower limit value of the numerical range may be replaced with a value shown in Examples.

In the present disclosure, the term “step” includes not only an independent step but also a step which cannot be clearly distinguished from other steps as long as the intended purpose of the step is achieved.

When an exemplary embodiment of the present disclosure is described with reference to a drawing, the configuration of the exemplary embodiment is not limited to the configuration illustrated in the drawing. Further, the sizes of the members in the drawings are conceptual, and the relative relationship in size between the members is not limited thereto.

In the present disclosure, each component may include a plurality of kinds of the relevant substances. In the present disclosure, in a case where the amount of each component in a composition is referred to and a plurality of kinds of substances corresponding to the component are present in the composition, it means the total amount of the plurality of kinds of substances present in the composition, unless otherwise specified.

In the present disclosure, a plurality of kinds of particles corresponding to each component may be contained in the composition. In a case where a plurality of kinds of particles corresponding to each component are present in a composition, the particle size of the component means a value for a mixture of the plurality of kinds of particles present in the composition unless otherwise specified.

In the present disclosure, “(meth)acrylic” means at least one of acrylic or methacrylic, and “(meth)acrylate” means at least one of acrylate or methacrylate.

In the present disclosure, carbon black is not regarded as inorganic particles.

In the present disclosure, the “toner for developing an electrostatic charge image” is also referred to as “toner”, the “carrier for developing an electrostatic charge image” is also referred to as “carrier”, and the “electrostatic charge image developer” is also referred to as “developer”.

(Method for Producing Carrier for Developing Electrostatic Charge Image)

A method for producing a carrier for developing an electrostatic charge image according to an exemplary embodiment includes: a mixing step of preparing a coating liquid containing a resin, conductive particles, and a solvent, adding the coating liquid and magnetic particles to a mixer having a stirring blade, and mixing the coating liquid and the magnetic particles to obtain a mixture; and a drying step of evaporating and drying the solvent from the mixture to produce a carrier having a resin coating layer on the surfaces of the magnetic particles, wherein a viscosity μ of the coating liquid when being added to the mixer is more than 60 mPa·s and 1,000 mPa·s or less, and a value of a ratio μ/W of the viscosity μ (mPa·s) to an amount W (parts by mass) of the resin coating layer with respect to 100 parts by mass of the magnetic particles in the carrier is 20 or more and 500 or less.

Further, a carrier for developing an electrostatic charge image according to an exemplary embodiment is a carrier for developing an electrostatic charge image produced by the method for producing a carrier for developing an electrostatic charge image according to the exemplary embodiment.

Since the aggregation structure of the conductive particles cannot be sufficiently broken or reaggregation occurs even in a case where the aggregation structure is broken in a stage before the preparation of the coating liquid to be added to the mixer, it is necessary to disperse the conductive particles in the process of forming the resin coating layer on the magnetic particles by adding the coating liquid and the magnetic particles to the mixer, stirring and mixing the coating liquid and the magnetic particles, and starting drying.

In the process of forming the resin coating layer on the magnetic particles by adding the coating liquid and the magnetic particles to a mixer, stirring and mixing the coating liquid and the magnetic particles, and starting drying, in a case where the coating liquid has a low viscosity, the coatability is high, but the dispersion force to disperse the conductive particles is weak since the stirring power for mixing the magnetic particles and the coating liquid is not applied. Conversely, in a case where the coating liquid has a high viscosity, the coatability is low, but the dispersion force to disperse the conductive particles is strong since the stirring power is applied. This is because the magnetic particles serve as a dispersion medium and disperse the conductive particles in the coating liquid.

Specifically, in a case where a resin coating layer having a high coating amount is formed using a coating liquid having a low viscosity, the coverage becomes high; however, in a case where the viscosity is too low, the conductive particles in the resin coating layer do not disperse smoothly, many aggregates of the conductive particles are present on the surface of the carrier, and the amount of the conductive particle powder that leaves after solvent drying increases.

However, if the viscosity of the coating liquid is too high, the coverage becomes low even in the case of forming a resin coating layer with a high coating amount, and therefore an appropriate viscosity is required.

In the method for producing a carrier for developing an electrostatic charge image according to the exemplary embodiment, by setting the viscosity μ of the coating liquid in the above range and setting the value of the ratio μ/W of the viscosity μ to the amount W (parts by mass) of the resin coating layer with respect to 100 parts by mass of the magnetic particles in the above range depending on the viscosity μ, a carrier for developing an electrostatic charge image is obtained, which has a high coverage with the resin coating layer, in which exposure of the conductive particles on the surface of the obtained carrier is suppressed, and which is excellent in suppressing color dullness of an image to be obtained.

The method for producing a carrier for developing an electrostatic charge image according to the exemplary embodiment will now be described in detail.

The dispersion step of producing the coating liquid used in the exemplary embodiment may be performed using an in-liquid disperser, and from the viewpoint of uniform dispersibility, it is preferable that the dispersion step is performed using a device in which collision or shearing force is generated by stirring a dispersion medium such as glass beads together with a liquid for dispersion using an agitator, and aggregates are dispersed by this force. These dispersion chambers are classified into a vertical type and a horizontal type, and the shape of the agitator is classified into a disk type, a pin type, a single rotor type, and the like. As the particle size of the dispersion medium is smaller, the dispersion proceeds more, but as the particle size is smaller, the separation from the dispersion liquid is inhibited, and therefore it is necessary to select an appropriate particle size. The particle size of commercially available particles is 2 mm to 0.05 mm, but is preferably around 1 mm from the viewpoint of increasing the viscosity of the dispersion liquid.

As a result, since the magnetic particles in the mixer have a smaller diameter than that of the dispersion medium, dispersion proceeds in the dispersion step.

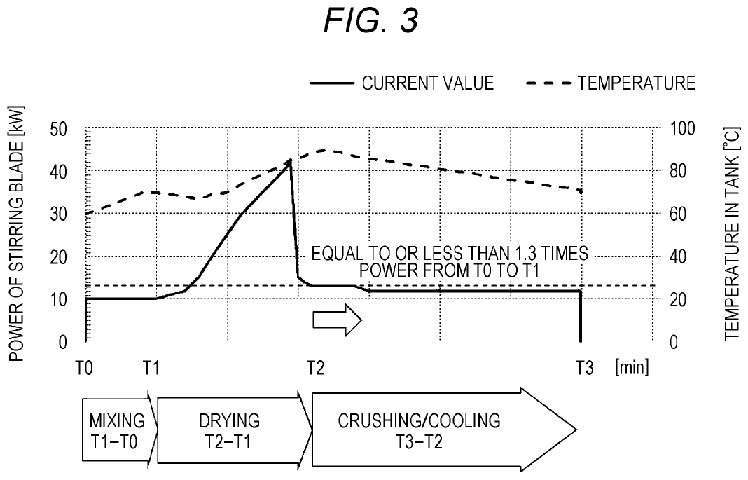

In the method for producing a carrier for developing an electrostatic charge image according to the exemplary embodiment, for example, it is considered that the fluctuation of the load power value of the stirring blade shown in FIG. 3 occurs.

FIG. 3 shows a schematic graph showing a fluctuation of load power value of a stirring blade and a fluctuation of temperature inside a mixer with time in an example of the method for producing a carrier for developing an electrostatic charge image according to the exemplary embodiment.

The vertical axis on the left side of FIG. 3 represents the load power value (kW) of the stirring blade, the vertical axis on the right side represents the temperature (° C.) inside the mixer, and the horizontal axis represents the elapsed time (min).

At T0 shown in FIG. 3, the coating liquid and the magnetic particles are put into the mixer, from T0 to T1, the coating liquid and the magnetic particles are mixed, from T1 to T2, the solvent contained in the coating liquid is evaporated while the pressure is reduced, and the drying of the carrier is completed, and from T2 to T3, the dried carrier is crushed and cooled as necessary. Furthermore, at T3, the stirring in the mixer is completed, and the carrier is taken out from the mixer.

The fluctuation of the load power value of the stirring blade shown in FIG. 3 is as follows.

The load power value of the stirring blade is substantially constant from T0 to T1.

From T1 to T2, as the solvent evaporates, the viscosity of the mixture of the coating liquid and the magnetic particles in the mixer increases, and the load power value of the stirring blade continues to increase until the drying of the carrier is completed. When the drying of the carrier is completed, the load power value of the stirring blade rapidly decreases to a value equal to or less than 1.3 times the load power value of the stirring blade from T0 to T1.

From T2 to T3, the load power value of the stirring blade becomes almost constant again.

T is the time from T2 to T3.

The fluctuation of the temperature in the mixer shown in FIG. 3 is as follows.

The temperature gradually increases to a set temperature (for example, a jacket temperature) from T0 to T1.

The temperature does not stably increase from T1 to T2 due to the heat of vaporization of the solvent, but as a whole, the temperature gradually increases as the drying of the carrier proceeds.

From T2 to T3, the temperature gradually increases according to the temperature set at the time of drying, and the temperature gradually decreases according to the set cooling temperature (for example, the jacket temperature) when cooling is started.

<Value of μ/W>

In the method for producing a carrier for developing an electrostatic charge image according to the exemplary embodiment, the value of the ratio μ/W of the viscosity μ(mPa·s) of the coating liquid when being added to the mixer in the mixing step to the amount W (parts by mass) of the resin coating layer with respect to 100 parts by mass of the magnetic particles in the produced carrier is 20 or more and 500 or less, and from the viewpoint of the property of suppressing color dullness of an image to be obtained (hereinafter also simply referred to as “color dullness suppressing property”), the value is preferably 25 or more and 300 or less, more preferably 30 or more and 150 or less, and particularly preferably 30 or more and 100 or less.

The amount W of the resin coating layer with respect to 100 parts by mass of the magnetic particles in the produced carrier is preferably 0.5 parts by mass or more and 7 parts by mass or less, more preferably 1 part by mass or more and 5 parts by mass or less, even more preferably 2 parts by mass or more and 4 parts by mass or less, and particularly preferably 2.5 parts by mass or more and 3.5 parts by mass or less with respect to 100 parts by mass of the magnetic particles, from the viewpoint of the color dullness suppressing property.

The amount of the resin coating layer in the produced carrier is preferably 0.5% by mass or more and 5% by mass or less, more preferably 1.5% by mass or more and 4% by mass or less, and particularly preferably 2.5% by mass or more and 3.5% by mass or less with respect to the total mass of the carrier, from the viewpoint of the color dullness suppressing property.

The viscosity μ(mPa·s) of the coating liquid when being added to the mixer in the mixing step in the exemplary embodiment is measured at a temperature at the time of adding the coating liquid to the mixer using a vibration viscosimeter (VISCOMATE VM-10A, manufactured by SEKONIC CORPORATION).

In the exemplary embodiment, a method for measuring the amount W (parts by mass) of the resin coating layer with respect to 100 parts by mass of the magnetic particles in the produced carrier is not particularly limited. For example, after at least the resin component in the resin coating layer is dissolved with a solvent or the like to remove the resin coating layer, the magnetic particles are dried, and W may be obtained from the weights before and after the removal.

<Mixing Step>

The method for producing a carrier for developing an electrostatic charge image according to the exemplary embodiment includes a mixing step of adding a coating liquid containing a resin, conductive particles, and a solvent and magnetic particles to a mixer having a stirring blade, and mixing the coating liquid and the magnetic particles to obtain a mixture, and the viscosity μ of the coating liquid when being added to the mixer is more than 60 mPa·s and 1,000 mPa·s or less.

The viscosity μ of the coating liquid when being added to the mixer in the mixing step is more than 60 mPa·s and 1,000 mPa·s or less at the temperature of the coating liquid at the time of addition, and is preferably 80 mPa·s or more and 800 mPa·s or less, more preferably 100 mPa·s or more and 600 mPa·s or less, and particularly preferably 100 mPa·s or more and 300 mPa·s or less from the viewpoint of the color dullness suppressing property.

The mixer used in the exemplary embodiment may be any mixer having a stirring blade, and a known mixer is used, but from the viewpoint of drying properties, a vacuum mixer is preferable.

In addition, the mixer used in the exemplary embodiment is preferably a batch mixer, and more preferably a batch vacuum mixer, from the viewpoints of mixing properties and color dullness suppressing property.

The batch mixer is preferably a blade type kneader, and the direction of the rotation axis of the blade may be vertical or horizontal. Examples of the vertical type include a spiral mixer (manufactured by AICOHSHA MFG. CO., LTD.) and a planetary mixer (manufactured by INOUE MFG., INC.), and examples of the horizontal type include a kneader (manufactured by INOUE MFG., INC.). Among these, from the viewpoint of mixing properties and color dullness suppressing property, a biaxial horizontal type kneader is particularly preferable.

The mixer preferably has a temperature control structure capable of heating and cooling the mixture in the mixing tank under reduced pressure and a mechanism capable of detecting the stirring power value of the stirring blade.

The temperature control structure is not limited to any particular structure and preferably has a jacket structure.

Specific examples of the shape of the stirring blade include, but are not limited to, Banbury type, sigma type, Z type, spiral type, and fishtail type.

The diameter D of the stirring blade is not particularly limited and may be a size suitable for the mixer to be used. Further, the diameter D of the stirring blade in the exemplary embodiment is the maximum outer diameter of a portion through which the stirring blade passes by rotation in a plane perpendicular to the rotation axis.

The rotation speed N of the stirring blade is preferably 10 rpm or more and 200 rpm or less, more preferably 15 rpm or more and 100 rpm or less, and particularly preferably 20 rpm or more and 60 rpm or less, from the viewpoint of the production rate of the carrier and the color dullness suppressing property.

A clearance between a stirring tank and the stirring blade in the mixer is not limited, and has a size in accordance with the mixer used. This is because not only the carrier accumulated at the bottom portion cannot be crushed in a case where the clearance is wide, but also the shearing force in the crushing is determined not only by the circumferential speed of the stirring blade and the amount of stirring work but also by the clearance. Therefore, it is preferable that the clearance is narrower, but since there is a limit to the clearance due to limitations in manufacturing of the device, the value of clearance/diameter of the stirring blade between the outer periphery of the stirring blade and the clearance in the stirring tank is preferably 5% or less and more preferably 3.5% or less.

Stirring with the stirring blade is preferably continued during the mixing step.

From the viewpoint of the color dullness suppressing property, the stirring conditions in the mixing step preferably satisfy Expression 1, and more preferably satisfy Expression 1-1.

1×10⁴≤amount of stirring work (=circumferential speedπDN×stirring time T)×viscosityμ(mPa·s)≤5×10⁵ Expression 1

2×10⁴≤amount of stirring work (=circumferential speedπDN×stirring time T)×viscosityμ(mPa·s)≤4×10⁵ Expression 1-1

In Expressions 1 and 1-1, D represents a diameter (m) of the stirring blade, N represents a rotation speed (rps) of the stirring blade, and T represents a stirring time (s) from the addition of the coating liquid to start of evaporation and drying of the solvent.

The temperature in the mixer in the mixing step is preferably not less than a temperature 50° C. lower than the boiling point of the solvent and not more than a temperature 20° C. lower the boiling point of the solvent depending on the pressure in the mixer.

When the coating liquid contains two or more kinds of solvents, the boiling point of the solvent contained in the resin coating layer is defined as the boiling point of the solvent having a lower boiling point among the two or more kinds of solvents contained in the coating liquid.

The solid content concentration S of the mixture excluding the magnetic particles is preferably 10% by mass or more and 30% by mass or less and more preferably 15% by mass or more and 25% by mass or less, from the viewpoint of the color dullness suppressing property.

The amounts of the coating liquid and the magnetic particles used in the mixing step are not particularly limited and may be appropriately selected depending on the disperser used, and the like.

The amount ratio between the coating liquid and the magnetic particles may be appropriately selected depending on the concentration of the coating liquid, the thickness of the resin coating layer to be formed, and the like.

Further, in the mixing step, in addition to the coating liquid and the magnetic particles, other components to be included in the resin coating layer such as particles may be added to the mixer.

The details of the coating liquid containing a resin and a solvent, the magnetic particles, and other components used in the mixing step will be collectively described below.

<Drying Step>

The method for producing a carrier for developing an electrostatic charge image according to the exemplary embodiment includes a drying step of evaporating and drying the solvent from the mixture to extract a carrier having a resin coating layer on the surfaces of the magnetic particles.

In the drying step, the solvent may be evaporated by heating under normal pressure, under reduced pressure, or by heating under reduced pressure, but the solvent is preferably evaporated by heating under reduced pressure because the solvent can be dried without being heated to a temperature equal to or more than the glass transition temperature Tg of the resin from the boiling point of the solvent.

The air pressure in the drying step is not particularly limited and may be appropriately selected depending on the glass transition temperature of the resin and the solvent used, but is preferably 0.1 kPa-a or more and 95 kPa-a or less, and more preferably 5 kPa-a or more and 80 kPa-a or less, from the viewpoint of the evaporation rate of the solvent and the color dullness suppressing property.

kPa-a represents an air pressure (kPa) based on an absolute pressure.

The drying step is preferably performed in the mixer from the viewpoint of color dullness suppressing property and simplicity.

A decompression element in the mixer is not particularly limited, and a known decompression element such as a decompression pump is used.

In addition, the evaporated solvent may be recovered by a solvent recovery element such as a cooling trap.

In the drying step, the temperature of the carrier when the carrier is taken out from the mixer is preferably equal to or less than a temperature 10° C. lower than the glass transition temperature Tg of the resin contained in the resin coating layer from the viewpoint of color dullness suppressing property.

When the cooling step described below is performed after the drying step, the temperature of the carrier when the carrier is taken out from the mixer is preferably equal to or less than the glass transition temperature Tg of the resin contained in the resin coating layer, and more preferably equal to or less than a temperature 20° C. lower than the glass transition temperature Tg of the resin contained in the resin coating layer.

This is because when the carrier crushed by the mixer is collected in a container and stored in the container until it is sieved through a sieve having an arbitrary opening, since the coating resin is not fixed as the storage temperature is closer to the glass transition temperature Tg of the coating resin of the carrier, the resin in the resin coating layer is unevenly distributed depending on the storage site in the tank by the self weight applied to the carrier in the tank, and the amount of free resin may not be stabilized. Therefore, when the cooling step described below is performed, it is preferable to perform cooling with a cooling device continuously after the drying step in order to suppress the generation of coating residues.

<Cooling Step>

The method for producing a carrier for developing an electrostatic charge image according to the exemplary embodiment preferably further includes a cooling step of cooling the carrier to equal to or less than (a glass transition temperature Tg of the resin contained in the resin coating layer −20° C.) by a cooling device continuously after the drying step from the viewpoint of color dullness suppressing property.

Examples of the cooling device include a fluidized bed device, a paddle-type mixer, and a screw mixer, but the fluidized bed device is preferable from the viewpoint of color dullness suppressing property. By cooling the mixture using a fluidized bed device capable of mixing without stirring, generation of free resin is further suppressed, and a carrier having more stable quality is obtained. The fluidized bed device is not particularly limited, and examples thereof include a fluidized bed device using only flowing air and a vibrating fluidized bed that assists fluidization by vibration.

The fluidized bed device may be any device as long as it can discharge a gas that has been dehumidified at a temperature equal to or less than the cooling reaching temperature of the object to be cooled from the bottom portion of the device, and depending on the required cooling capacity, the gas may be cooled to a temperature equal to or less than room temperature, or cooling water may be circulated by using the framework of the fluidized bed device as a jacket structure.

The fluidized bed device is not particularly limited, and a known fluidized bed device is used.

“Continuously after the drying step” means that the carrier taken out from the mixer in the drying step may be directly charged into the fluidized bed device, and it is preferable that the carrier is directly charged into the fluidized bed device from the mixer in the drying step.

Since the cooling rate by the fluidized bed device depends on the temperature of the fluidizing gas, the flow rate of the fluidizing gas per unit weight of the carrier, and the conductive heat transfer efficiency determined by the stirring state in the tank determined by the superficial velocity based on the minimum fluidization velocity Umf described later, the lower the fluidizing gas temperature and the higher the fluidization velocity, the shorter the cooling time. However, as the fluidization velocity is higher, the frictional force between the carrier particles in the device is increased to generate coating residues.

Accordingly, the superficial velocity v (m/s) of the fluidizing gas during cooling in the cooling step is preferably 2 times or more and 10 times or less of the minimum fluidization velocity Umf, more preferably 3 times or more and 8 times or less of the minimum fluidization velocity Umf, and particularly preferably 3 times or more and 5 times or less of the minimum fluidization velocity Umf, from the viewpoint of the cooling rate and the color dullness suppressing property.

The minimum fluidization velocity Umf can be experimentally obtained by the following equation from the flow rate at a change point at which the pressure of the fluidizing gas starts to be stabilized after increasing.

Minimum fluidization velocity Umf (m/s)=flow rate (m³/s) at change point/cross-sectional area (m²) of fluidized bed device

The superficial velocity v of the fluidizing gas during cooling in the cooling step is not particularly limited, but is preferably 10 mm/s or more and 100 mm/s or less, and more preferably 20 mm/s or more and 50 mm/s or less.

The fluidizing gas in the fluidized bed device is not particularly limited, and air, nitrogen, argon, or the like can be used. Among these, air is preferable.

The fluidizing gas is preferably a dehumidified gas, preferably a gas having a relative humidity of 30% or less, more preferably a gas having a relative humidity of 20% or less, and particularly preferably a gas having a relative humidity of 10% or less.

In the cooling step, from the viewpoint of the color dullness suppressing property, cooling is preferably performed to a temperature equal to or less than a temperature 20° C. lower than the glass transition temperature Tg of the resin contained in the resin coating layer, more preferably performed to a temperature equal to or less than a temperature 25° C. lower than the glass transition temperature Tg of the resin contained in the resin coating layer and particularly preferably performed to a temperature equal to or more than 25° C. and equal to or less than a temperature 30° C. lower than the glass transition temperature Tg of the resin contained in the resin coating layer.

The cooling time in the cooling step is not particularly limited, but is preferably 10 minutes or more and 360 minutes or less, more preferably 30 minutes or more and 240 minutes or less, and particularly preferably 60 minutes or more and 150 minutes or less from the viewpoints of the production rate of the carrier and the color dullness suppressing property.

The method for producing a carrier for developing an electrostatic charge image according to the exemplary embodiment may include other steps in addition to the mixing step, the drying step, and the cooling step.

The other steps are not particularly limited, and may include known steps.

The method for producing a carrier for developing an electrostatic charge image according to the exemplary embodiment preferably further includes a step of preparing magnetic particles and a step of preparing a coating liquid containing a resin and a solvent.

Furthermore, it is preferable that the method for producing a carrier for developing an electrostatic charge image according to the exemplary embodiment further includes a coarse powder removing step of sieving the produced carrier to remove coarse powder.

<Physical Properties of Carrier>

The volume-average particle size of the carrier for developing an electrostatic charge image obtained by the method for producing a carrier for developing an electrostatic charge image according to the exemplary embodiment is preferably 10 μm or more and 500 μm or less, more preferably 15 μm or more and 100 μm or less, and particularly preferably 20 μm or more and 60 μm or less.

The volume-average particle size of the magnetic particles and the carrier in the exemplary embodiment is a value measured by a laser diffraction particle size distribution analyzer LA-700 (manufactured by HORIBA, Ltd.). Specifically, with respect to particle size ranges (channels) obtained by dividing a particle size distribution obtained by a measuring apparatus, a volume cumulative distribution is drawn from a small particle size side, and a particle size at a cumulative percentage of 50% is defined as a volume-average particle size.

The amount of free resin in the carrier for developing an electrostatic charge image obtained by the method for producing a carrier for developing an electrostatic charge image according to the exemplary embodiment is preferably 200 ppm or less, more preferably 100 ppm or less, and particularly preferably 75 ppm or less, from the viewpoint of color dullness suppressing property.

A method for measuring the amount of the free resin in the carrier for developing an electrostatic charge image in the exemplary embodiment is as follows.

A certain amount of the carrier is weighed and dispersed in water, and the dispersion liquid is filtered with the carrier being fixed with a magnet. The filter paper is dried, and the amount of free resin is calculated from the mass difference before and after the filtration and the amount of the weighed carrier according to the following formula.

Free resin amount(ppm)=filter paper increase amount(g)/carrier(g)

The proportion of the aggregates after 75 μm sieving in the carrier for developing an electrostatic charge image obtained by the method for producing a carrier for developing an electrostatic charge image according to the exemplary embodiment is preferably 5% by number or less, more preferably 1% by number or less, even more preferably 0. 1% by number or less, and particularly preferably 0.01% by number or less, from the viewpoint of color dullness suppressing property.

A method for measuring the proportion of the aggregates after 75 μm sieving in the carrier for developing an electrostatic charge image in the exemplary embodiment is as follows.

The carrier is sieved using a 75 μm sieve, the sieved carrier is spread so as not to overlap as much as possible, a scanning electron microscope (SEM) image at a magnification of 350 is captured, and a rate of the number of carrier particles that have not been crushed to primary particles in the number of carrier particles in one visual field is measured.

The fluidity of the carrier for developing an electrostatic charge image in the exemplary embodiment is preferably 20 seconds/50 g or more and 50 seconds/50 g or less, more preferably 22 seconds/50 g or more and 35 seconds/50 g or less, and particularly preferably 25 seconds/50 g or more and 30 seconds/50 g or less, from the viewpoint of density change suppressing properties in an image to be obtained.

The fluidity of the carrier for developing an electrostatic charge image according to the exemplary embodiment is measured at 25° C. and 50% RH according to JIS Z2502 (2020).

<Magnetic Particles>

As the magnetic particles used in the exemplary embodiment, known magnetic particles are used.

As the magnetic particles, known materials are used. Examples thereof include magnetic metals such as iron, nickel, and cobalt, alloys of these magnetic metals with manganese, chromium, rare earth elements, and the like, magnetic oxides such as iron oxide, ferrite, and magnetite, and resin-dispersed magnetic particles in which a conductive material or the like is dispersed in a matrix resin.

Examples of the resin used for the resin-dispersed magnetic particles include, but are not limited to, polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resins containing organosiloxane bonds or modified products thereof, fluororesins, polyesters, polycarbonates, phenol resins, and epoxy resins.

Among them, the magnetic particles are preferably magnetic oxide particles, and more preferably ferrite particles.

—Ferrite Particles—

Ferrite is generally represented by (MO)ₓ(Fe₂O₃)_{Y}. In the formula, M is mainly Mn, but it is also possible to combine at least one kind or several kinds selected from the group consisting of Li, Ca, Sr, Sn, Cu, Zn, Ba, Fe, Ti, Ni, Al, Co and Mo. Further, X and Y represent molar ratios and satisfy the condition of X+Y=100. In general, the properties of ferrite particles change depending on the composition and structure thereof.

The ferrite particles used in the exemplary embodiment are not particularly limited, but can be produced as follows, for example.

Powder of a metal oxide or a metal salt as a raw material is mixed and subjected to calcination using a rotary kiln or the like to obtain a calcined product. Here, examples of metal oxides or metal salts that are raw materials include Fe₂O₃, MnO₂, SrCO₃, and Mg(OH)₂. For example, by adjusting the amount of SrCO₃, the content of strontium in the ferrite particles is set to 0.1% by mass or more and 1.0% by mass or less. The temperature of the calcination may be 800° C. or more and 1,000° C. or less, and the time of the calcination may be 6 hours or more and 10 hours or less. The obtained calcined product is pulverized by a known pulverization method. Specifically, polyvinyl alcohol, water, a surfactant, and a defoaming agent are added, and the mixture is pulverized by a mortar, a ball mill, a jet mill, or the like. The calcined product is pulverized until the average particle size becomes, for example, 4 μm or more and 10 μm or less. Next, the pulverized calcined product is granulated by a spray dryer and dried. This dried calcined product is calcined again (re-calcined), and the contained organic substance is removed to obtain a re-calcined product. The temperature of the re-calcination may be 800° C. or more and 1,000° C. or less, and the time of the re-calcination may be 5 hours or more and 10 hours or less. Polyvinyl alcohol, water, a surfactant and a defoaming agent are added to the obtained re-calcined product, and the mixture is pulverized by a mortar, a ball mill, a jet mill or the like. The re-calcined product is pulverized, for example, until the average particle size becomes 4 μm or more and 8 μm or less. Next, the pulverized re-calcined product is granulated with a spray dryer and dried. The dried granulated product is fired (main firing) using a rotary kiln or the like to obtain a main fired product. Here, the temperature of the main firing may be 1,000° C. or more and 1,400° C. or less, and the time of the main firing may be 3 hours or more and 6 hours or less. The main fired product is subsequently subjected to a crushing step and a classification step to obtain ferrite particles.

The volume-average particle size of the magnetic particles used in the exemplary embodiment is preferably 10 μm or more and 500 μm or less, more preferably 15 μm or more and 100 μm or less, and particularly preferably 20 μm or more and 60 μm or less.

The average particle size of the fired product or the ferrite particles refers to a value measured using a laser diffraction/scattering particle size distribution analyzer (LS Particle Size ANalyzer: LS13 320, manufactured by Beckman Coulter, Inc.). With respect to particle size ranges (channels) obtained by dividing the obtained particle size distribution, a cumulative distribution is drawn from a small particle size side, and a particle size at a cumulative percentage of 50% is defined as a volume-average 50% particle size.

The BET specific surface area of the magnetic particles is preferably 0.10 m²/g or more and 0.35 m²/g or less, more preferably 0.11 m²/g or more and 0.28 m²/g or less, and still more preferably 0.12 m²/g or more and 0.24 m²/g or less, from the viewpoint of long-term image quality stability and density change suppressing properties. In addition, in a case where the BET specific surface area of the magnetic particles is in the above-described range, an appropriate amount of the coating resin enters gaps between the magnetic particles, deterioration of the resin coating layer due to an anchoring effect can be suppressed, and long-term image quality stability and density change suppressing properties are improved.

The BET specific surface area of the magnetic particles is measured with nitrogen substitution by a three point method using an SA3100 specific surface area measuring device (manufactured by Beckman Coulter, Inc.). Specifically, 5 g of the magnetic particles are put into a cell, a deaeration treatment is performed at 60° C. for 120 minutes, and the measurement is performed using a mixed gas of nitrogen and helium (30: 70).

As a method for separating the magnetic particles from the carrier, more specifically, for example, 20 g of the resin-coated carrier is put into 100 mL of toluene. Ultrasonic waves are applied for 30 seconds under the condition of 40 kHz. The magnetic particles and the resin solution are separated using any filter paper according to the particle size. The magnetic particles remaining on the filter paper are washed by causing 20 mL of toluene to flow from above the magnetic particles. Next, the magnetic particles remaining on the filter paper are collected. The collected magnetic particles are placed in 100 mL of toluene in the same manner, and ultrasonic waves are applied thereto for 30 seconds under the condition of 40 kHz. The solution is filtered in the same manner, washed with 20 mL of toluene, and then collected. This is performed 10 times in total. Finally, the collected magnetic particles are dried, and the BET specific surface area is measured under the above conditions.

The arithmetical mean height Ra (JIS B0601:2001) of the roughness curve of the magnetic particles is preferably 0.1 μm or more and 1 μm or less, and more preferably 0.2 μm or more and 0.8 μm or less.

The arithmetical mean height Ra of the roughness curve of the magnetic particles is obtained by observing the magnetic particles at an appropriate magnification (for example, a magnification of 1,000) using a surface shape measurement device (for example, “Ultra-deep Color 3D Profile Measuring Microscope VK-9700” manufactured by Keyence Corporation), obtaining a roughness curve at a cut-off value of 0.08 mm, and extracting a reference length of 10 μm from the roughness curve in a direction of an average line thereof. Ra of 100 magnetic particles is arithmetically averaged.

With respect to the magnetic force of the magnetic particles, the saturation magnetization in a magnetic field of 3,000 oersted is preferably 50 emu/g or more, and more preferably 60 emu/g or more. The saturation magnetization is measured using a vibrating sample magnetometer VSMP 10-15 (manufactured by Toei Industry Co., Ltd.). The measurement sample is packed in a cell having an inner diameter of 7 mm and a height of 5 mm and set in the device. In the measurement, an applied magnetic field is applied and swept to a maximum of 3,000 oersted. Then, the applied magnetic field is reduced, and a hysteresis curve is prepared on the recording sheet. Saturation magnetization, residual magnetization, and coercive force are determined from the curve data.

The volume electrical resistance (volume resistivity) of the magnetic particles is preferably 1×10⁵Ω·cm or more and 1×10⁹Ω·cm or less, and more preferably 1×10⁷Ω·cm or more and 1×10⁹Ω·cm or less.

The volume electrical resistance (Ω·cm) of the magnetic particles is measured as follows. A measurement target is placed flat on a circular jig having a 20 cm² electrode plate such that the measurement target has a thickness of 1 mm or more and 3 mm or less to form a layer. The 20 cm² electrode plate is placed thereon to sandwich the layer. In order to eliminate the gap between the particles of the measurement target, a load of 4 kg is applied to the electrode plate disposed on the layer, and then the thickness (cm) of the layer is measured. Both the electrodes above and below the layer are connected to an electrometer and a high-voltage power supply generator. A high voltage is applied to both the electrodes so that the electric field becomes 103.8 V/cm, and the value (A) of the current flowing then is read. The measurement environment is a temperature of 20° C. and a relative humidity of 50%. The volume electrical resistance (Ω·cm) of the measurement target is calculated by the following equation.

R=E×20/(I−I₀)/L

In the equation, R represents a volume electrical resistance (Ω·cm) of a measurement target, E represents an applied voltage (V), I represents a current value (A), I₀ represents a current value (A) at an applied voltage of 0 V, and L represents a layer thickness (cm). The coefficient 20 represents the area (cm²) of the electrode plate.

<Resin Coating Layer>

A carrier for developing an electrostatic charge image produced by the method for producing a carrier for developing an electrostatic charge image according to the exemplary embodiment includes a resin coating layer that coats the magnetic particles.

Examples of the resin constituting the resin coating layer include styrene-acrylic acid copolymers; polyolefin-based resins such as polyethylene and polypropylene; polyvinyl-based or polyvinylidene-based resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; straight silicone resins including an organosiloxane bond or modified products thereof, fluororesins such as polytetrafluoroethylene, polyvinyl fluoride, polyvinylidene fluoride, and polychlorotrifluoroethylene; polyesters; polyurethanes; polycarbonates; amino resins such as urea-formaldehyde resins; and epoxy resins.

Among these, the resin constituting the resin coating layer preferably contains an acrylic resin, more preferably contains 50% by mass or more of an acrylic resin with respect to the total mass of the resins in the resin coating layer, and particularly preferably contains 80% by mass or more of an acrylic resin with respect to the total mass of the resins in the resin coating layer, from the viewpoint of chargeability, external additive adhesion controllability, and density change suppressing properties.

From the viewpoint of density change suppressing properties, it is preferable that the resin coating layer contains an acrylic resin having an alicyclic structure. As a polymerization component of the acrylic resin having an alicyclic structure, a lower alkyl ester of (meth)acrylic acid (for example, a (meth)acrylic acid alkyl ester having an alkyl group having 1 or more and 9 or less carbon atoms) is preferable, and specific examples thereof include methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. These monomers may be used alone or in combination of two or more kinds thereof.

It is preferable that the acrylic resin having an alicyclic structure contains cyclohexyl (meth)acrylate as a polymerization component. The content of the monomer unit derived from cyclohexyl (meth)acrylate contained in the acrylic resin having an alicyclic structure is preferably 75% by mass or more and 100% by mass or less, more preferably 85% by mass or more and 100% by mass or less, and still more preferably 95% by mass or more and 100% by mass or less with respect to the total mass of the acrylic resin having an alicyclic structure.

The weight-average molecular weight of the resin contained in the resin coating layer is preferably less than 300,000, more preferably less than 250,000, still more preferably 5,000 or more and less than 250,000, and particularly preferably 10,000 or more and 200,000 or less. When the weight-average molecular weight of the resin is in the above range, the smoothness of the resin-coated surface of the carrier is increased, and thus the amount of the external additive attached to the carrier is reduced, and the density change suppressing properties are improved.

The resin coating layer may contain conductive particles for the purpose of controlling charging and resistance. Examples of the conductive particles include carbon black and conductive particles among inorganic particles described below. Among these, carbon black is preferable.

The content of the conductive particles contained in the resin coating layer is preferably 0.1% by mass or more and 30% by mass or less, more preferably 0.5% by mass or more and 20% by mass or less, and even more preferably 1% by mass or more and 10% by mass or less with respect to the total mass of the resin coating layer, from the viewpoint of the color dullness suppressing property and the chargeability.

In addition, the addition amount of the conductive particles in the mixing step is preferably 0.1 parts by mass or more and 1 part by mass or less, more preferably 0.1 parts by mass or more and 0.5 parts by mass or less, even more preferably 0.1 parts by mass or more and 0.3 parts by mass or less, and particularly preferably 0.1 parts by mass or more and 0.2 parts by mass or less with respect to 100 parts by mass of the magnetic particles from the viewpoints of color dullness suppressing property and chargeability.

In addition, inorganic particles may be contained in the resin coating layer.

Examples of the inorganic particles contained in the resin coating layer include metal oxide particles such as silica, titanium oxide, zinc oxide, and tin oxide; metal compound particles such as barium sulfate, aluminum borate, and potassium titanate; and metal particles such as gold, silver, and copper.

Among these, from the viewpoint of density change suppressing properties, silica particles are preferable.

From the viewpoint of density change suppressing properties, the arithmetical average particle size of the inorganic particles in the resin coating layer is preferably 5 nm or more and 90 nm or less, more preferably 5 nm or more and 70 nm or less, even more preferably 5 nm or more and 50 nm or less, and particularly preferably 10 nm or more and 30 nm or less.

In the exemplary embodiment, the average particle size of the inorganic particles contained in the resin coating layer and the average thickness of the resin coating layer are determined by the following method.

The carrier is embedded with an epoxy resin and cut with a microtome to prepare a cross section of the carrier. An SEM image obtained by photographing the cross section of the carrier with a scanning electron microscope (SEM) is taken into an image processing analyzer and subjected to image analysis. One hundred inorganic particles (primary particles) in the resin coating layer are randomly selected, the circle-equivalent diameters (nm) of the inorganic particles are determined, and the arithmetic average thereof is defined as the average particle size (nm) of the inorganic particles. In addition, the thickness (μm) of the resin coating layer is measured at randomly selected 10 points per one carrier particle, the measurement is further performed on 100 carrier particles, and all the values are arithmetically averaged, which is defined as the average thickness (μm) of the resin coating layer.

The surface of the inorganic particles may be subjected to a hydrophobic treatment. Examples of the hydrophobizing agent include known organosilicon compounds having an alkyl group (for example, a methyl group, an ethyl group, a propyl group, or a butyl group), and specific examples thereof include an alkoxysilane compound, a siloxane compound, and a silazane compound. Among these, the hydrophobizing agent is preferably a silazane compound, and more preferably hexamethyldisilazane. The hydrophobizing agents may be used alone or in combination of two or more kinds thereof.

Examples of the method of performing the hydrophobic treatment on the inorganic particles using the hydrophobizing agent include a method of dissolving, using supercritical carbon dioxide, the hydrophobizing agent in supercritical carbon dioxide, and causing the hydrophobizing agent to adhere to the surfaces of the inorganic particles; a method of applying (for example, by spraying or coating) a solution containing the hydrophobizing agent and a solvent that dissolves the hydrophobizing agent to the surfaces of the inorganic particles in the atmosphere, and causing the hydrophobizing agent to adhere to the surfaces of the inorganic particles; and a method of adding a solution containing the hydrophobizing agent and a solvent that dissolves the hydrophobizing agent to an inorganic particle dispersion liquid in the atmosphere, retaining the mixed solution of the inorganic particle dispersion liquid and the solution, and drying the mixed solution.

The content of the inorganic particles contained in the resin coating layer is preferably 10% by mass or more and 60% by mass or less, more preferably 15% by mass or more and 55% by mass or less, and still more preferably 20% by mass or more and 50% by mass or less with respect to the total mass of the resin coating layer, from the viewpoint of density change suppressing properties.

The exposed area rate of the magnetic particles on the carrier surface is preferably 3% or more and 30% or less, more preferably 4% or more and 25% or less, and still more preferably 5% or more and 20% or less. The exposed area rate of the magnetic particles in the carrier can be controlled by the amount of the resin used for forming the resin coating layer, and the exposed area rate decreases as the amount of the resin relative to the amount of the magnetic particles increases.

That is, the coverage of the surface of the carrier with the resin coating layer is preferably 70% or more and 97% or less, more preferably 75% or more and 96% or less, still more preferably 80% or more and 95% or less, and particularly preferably 85% or more and 95% or less.

The exposed area rate of the magnetic particles and the coverage with the resin coating layer on the carrier surface are values obtained by the following methods.

A target carrier and magnetic particles obtained by removing the resin coating layer from the target carrier are prepared. Examples of the method for removing the resin coating layer from the carrier include a method in which the resin coating layer is removed by dissolving the resin component in an organic solvent, and a method in which the resin coating layer is removed by causing the resin component to disappear by heating at about 800° C. Both of the carrier and the magnetic particles are used as a measurement sample, the rate (atomic %) of Fe, C, and O on the surface of the sample is quantified by XPS, and (Fe rate of carrier)/(Fe rate of magnetic particles)×100 is calculated and defined as the exposed area rate (%) of the magnetic particles.

The coverage (%) with the resin coating layer is determined from (100−exposed area rate of magnetic particles).

The solvent used for forming the resin coating layer is not particularly limited as long as the solvent dissolves or disperses the resin, and examples thereof include aromatic hydrocarbons such as toluene and xylene; ketones such as acetone and methyl ethyl ketone; ethers such as tetrahydrofuran and dioxane; and alcohols such as methanol.

Among these, toluene is preferably exemplified.

Furthermore, the solid content of the coating liquid used for forming the resin coating layer is not particularly limited, but is preferably 5% by mass or more and 50% by mass or less, more preferably 10% by mass or more and 30% by mass or less, and particularly preferably 15% by mass or more and 30% by mass or less.

Further, the coating liquid may contain the conductive particles, the inorganic particles, or the like, or the conductive particles, the inorganic particles, or the like may be added separately from the coating liquid in the mixing step.

The average thickness of the resin coating layer is preferably 0.1 μm or more and 10 μm or less, more preferably 0.2 μm or more and 5 μm or less, and still more preferably 0.3 μm or more and 3 μm or less.

The average thickness of the resin coating layer is measured by the following method. The carrier is embedded in an epoxy resin or the like and cut with a diamond knife or the like to prepare a thin section. This thin section is observed with a transmission electron microscope (TEM) or the like, and a cross-sectional image of the plurality of carrier particles is captured. The thickness of the resin coating layer is measured at 20 points from the cross-sectional image of the carrier particles, and the average value thereof is adopted.

(Electrostatic Charge Image Developer)

The developer according to the exemplary embodiment is a two component developer containing a carrier for developing an electrostatic charge image produced by the method for producing a carrier for developing an electrostatic charge image according to the exemplary embodiment, and a toner. The toner contains toner particles, and an external additive as necessary.

In addition, a method for producing a developer according to an exemplary embodiment preferably includes the method for producing a carrier for developing an electrostatic charge image according to the exemplary embodiment.

The mixing ratio (mass ratio) of the carrier to the toner in the developer, that is, carrier: toner is preferably 100:1 to 100:30, and more preferably 100:3 to 100:20.

<Toner Particles>

The toner particles contain, for example, a binder resin, and if necessary, a colorant, a release agent, and other additives.

—Binder Resin—

Examples of the binder resin include homopolymers of monomers such as styrenes (for example, styrene, parachlorostyrene, and α-methylstyrene), (meth)acrylic acid esters (for example, methyl acrylate, ethyl acrylate, N-propyl acrylate, N-butyl acrylate, lauryl acrylate, 2-ethylhexyl acrylate, methyl methacrylate, ethyl methacrylate, N-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), and vinyl resins formed of copolymers obtained by combining two or more kinds of these monomers.

Examples of the binder resin also include non-vinyl resins such as epoxy resins, polyester resins, polyurethane resins, polyamide resins, cellulose resins, polyether resins, and modified rosins; mixtures of these and the vinyl resins; and graft polymers obtained by polymerizing vinyl monomers in the presence of these.

These binder resins may be used alone or in combination of two or more kinds thereof.

A polyester resin is suitable as the binder resin.

Examples of the polyester resin include known amorphous polyester resins. As the polyester resin, a crystalline polyester resin may be used in combination with the amorphous polyester resin. However, it is preferable that the content of the crystalline polyester resin is in the range of 2% by mass or more and 40% by mass or less (preferably 2% by mass or more and 20% by mass or less) with respect to the entire binder resin.

The term “crystalline” of the resin refers to having a clear endothermic peak rather than a stepwise change in endothermic amount in differential scanning calorimetry (DSC), and specifically refers to having a half-value width of the endothermic peak of 10° C. or less when measured at a heating rate of 10 (° C./min).

On the other hand, the term “amorphous” of the resin means that the half-value width exceeds 10° C., a stepwise change in endothermic amount is shown, or a clear endothermic peak is not observed.

Amorphous Polyester Resin

Examples of the amorphous polyester resin include a condensation polymer of a polyvalent carboxylic acid and a polyhydric alcohol. As the amorphous polyester resin, a commercially available product may be used, or a synthesized product may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, having 1 or more and 5 or less carbon atoms) alkyl esters thereof. Among these, for example, aromatic dicarboxylic acids are preferable as the polyvalent carboxylic acid.

As the polyvalent carboxylic acid, a trivalent or higher carboxylic acid having a crosslinked structure or a branched structure may be used in combination with the dicarboxylic acid. Examples of the trivalent or higher carboxylic acid include trimellitic acid, pyromellitic acid, anhydrides thereof, and lower (for example, having 1 or more and 5 or less carbon atoms) alkyl esters thereof.

The polyvalent carboxylic acid may be used singly or in combination of two or more kinds thereof.

Examples of the polyhydric alcohol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, as the polyhydric alcohol, for example, aromatic diols and alicyclic diols are preferable, and aromatic diols are more preferable.

As the polyhydric alcohol, a trihydric or higher polyhydric alcohol having a crosslinked structure or a branched structure may be used in combination with a diol. Examples of the trihydric or higher polyhydric alcohol include glycerin, trimethylolpropane, and pentaerythritol. The polyhydric alcohol may be used singly, or two or more kinds of polyhydric alcohols may be used in combination.

The glass transition temperature (Tg) of the amorphous polyester resin is preferably 50° C. or more and 80° C. or less, and more preferably 50° C. or more and 65° C. or less.

The glass transition temperature is obtained from a DSC curve obtained by differential scanning calorimetry (DSC) and, more specifically, obtained from “extrapolated glass transition onset temperature” described in a method for obtaining glass transition temperatures of JIS K7121:1987 “Testing Methods for Transition Temperatures of Plastics”.

The weight-average molecular weight (Mw) of the amorphous polyester resin is preferably 5,000 or more and 1,000,000 or less, and more preferably 7,000 or more and 500,000 or less.

The number-average molecular weight (Mn) of the amorphous polyester resin is preferably 2,000 or more and 100,000 or less.

The amorphous polyester resin preferably has a molecular weight distribution Mw/Mn of 1.5 or more and 100 or less, and more preferably 2 or more and 60 or less.

A weight-average molecular weight and a number-average molecular weight are measured by gel permeation chromatography (GPC). The measurement of the molecular weight by GPC is performed using GPC HLC-8120GPC manufactured by Tosoh Corporation as a measuring apparatus, using a column TSKgel SuperHM-M (15 cm) manufactured by Tosoh Corporation, and using THF as a solvent. The weight-average molecular weight and the number-average molecular weight are calculated from the measurement results using a molecular weight calibration curve prepared using monodisperse polystyrene standard samples.

The amorphous polyester resin can be obtained by a known production method. Specifically, for example, it can be obtained by a method in which the polymerization temperature is set to 180° C. or more and 230° C. or less, the pressure in the reaction system is reduced as necessary, and the reaction is performed while removing water or alcohol generated during condensation.

When the raw material monomers are not dissolved or compatible at the reaction temperature, a solvent having a high boiling point may be added as a dissolution auxiliary agent to dissolve the monomers. In this case, a polycondensation reaction is performed while the dissolution auxiliary agent is evaporated. In a case where a monomer having poor compatibility is present in the copolymerization reaction, it is preferable that the monomer having poor compatibility and an acid or an alcohol to be polycondensed with the monomer are condensed in advance and then polycondensed with the main component.

Crystalline Polyester Resin

Examples of the crystalline polyester resin include a polycondensate of a polyvalent carboxylic acid and a polyhydric alcohol. A commercially available product or a synthesized product may be used as the crystalline polyester resin.

Here, the crystalline polyester resin is preferably a polycondensate using a linear aliphatic polymerizable monomer rather than a polymerizable monomer having an aromatic ring in order to easily form a crystal structure.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid acid), aromatic dicarboxylic acids (for example, dibasic acids such as phthalic acid, isophthalic acid, terephthalic acid, and naphthalene-2,6-dicarboxylic acid), anhydrides thereof, and lower (for example, having 1 or more and 5 or less carbon atoms) alkyl esters thereof.

As the polyvalent carboxylic acid, a trivalent or higher carboxylic acid having a crosslinked structure or a branched structure may be used in combination with the dicarboxylic acid. Examples of the trivalent carboxylic acids include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, having 1 or more and 5 or less carbon atoms) alkyl esters thereof.

As the polyvalent carboxylic acid, a dicarboxylic acid having a sulfonic acid group or a dicarboxylic acid having an ethylenic double bond may be used in combination with these dicarboxylic acids.

The polyvalent carboxylic acid may be used singly or in combination of two or more kinds thereof.

Examples of the polyhydric alcohol include an aliphatic diol (for example, a linear aliphatic diol having 7 or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, as the aliphatic diol, 1,8-octanediol, 1,9-nonanediol, and 1,10-decanediol are preferable.

As the polyhydric alcohol, a trihydric or higher alcohol having a crosslinked structure or a branched structure may be used in combination with a diol. Examples of the trihydric or higher alcohol include glycerin, trimethylolethane, trimethylolpropane, and pentaerythritol.

The polyhydric alcohol may be used singly, or two or more kinds of polyhydric alcohols may be used in combination.

Here, the content of the aliphatic diol in the polyhydric alcohol is preferably 80 mol % or more, and more preferably 90 mol % or more.

The melting temperature of the crystalline polyester resin is preferably 50° C. or more and 100° C. or less, more preferably 55° C. or more and 90° C. or less, and even more preferably 60° C. or more and 85° C. or less.

The melting temperature is determined from a DSC curve obtained by differential scanning calorimetry (DSC) according to “melting peak temperature” described in “Determination of melting temperature” in JIS K7121:1987 “Testing Methods for Transition Temperatures of Plastics”.

The weight-average molecular weight (Mw) of the crystalline polyester resin is preferably 6,000 or more and 35,000 or less.

The crystalline polyester resin can be obtained, for example, by a known production method as in the case of the amorphous polyester resin.

The content of the binder resin is preferably 40% by mass or more and 95% by mass or less, more preferably 50% by mass or more and 90% by mass or less, and still more preferably 60% by mass or more and 85% by mass or less with respect to the entire toner particles.

—Colorant—

Examples of the colorant include pigments such as carbon black, chrome yellow, hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine-, xanthene-, azo-, benzoquinone-, azine-, anthraquinone-, thioindigo-, dioxazine-, thiazine-, azomethine-, indigo-, phthalocyanine-, aniline black-, polymethine-, triphenylmethane-, diphenylmethane-, and thiazole-based dyes.

As the colorant, one kind may be used alone, or two or more kinds may be used in combination.

As the colorant, a surface-treated colorant may be used as necessary, or a dispersant may be used in combination. A plurality of kinds of colorants may be used in combination.

The content of the colorant is preferably 1% by mass or more and 30% by mass or less and more preferably 3% by mass or more and 15% by mass or less with respect to the entire toner particles.

—Release Agent—

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably 50° C. or more and 110° C. or less, and more preferably 60° C. or more and 100° C. or less.

The melting temperature is determined from a DSC curve obtained by differential scanning calorimetry (DSC) according to “melting peak temperature” described in “Determination of melting temperature” in JIS K7121:1987 “Testing Methods for Transition Temperatures of Plastics”.

The content of the release agent is preferably 1% by mass or more and 20% by mass or less and more preferably 5% by mass or more and 15% by mass or less with respect to the entire toner particles.

—Other Additives—

Examples of the other additives include known additives such as a magnetic substance, a charge control agent, and an inorganic powder. These additives are contained in toner particles as internal additives.

—Characteristics of Toner Particles, Etc.—

The toner particles may be toner particles having a single-layer structure or toner particles having a so-called core-shell structure composed of a core (core particles) and a coating layer (shell layer) coating the core.

The toner particles having a core-shell structure preferably include, for example, a core containing a binder resin and optionally other additives such as a colorant and a release agent, and a coating layer containing a binder resin.

The toner particles preferably have a volume-average particle size (D50v) of 2 μm or more and 10 μm or less, and more preferably 4 μm or more and 8 μm or less.

The volume-average particle size (D50v) of the toner particles is measured using a Coulter Multisizer II (manufactured by Beckman Coulter, Inc.) and ISOTON-II (manufactured by Beckman Coulter, Inc.) as an electrolyte.

In the measurement, 0.5 mg or more and 50 mg or less of a measurement sample is added to 2 ml of a 5% by mass aqueous solution of a surfactant (preferably sodium alkylbenzene sulfonate) as a dispersant. This is added to 100 ml or more and 150 ml or less of the electrolyte.

The electrolyte in which the sample is suspended is subjected to a dispersion treatment with an ultrasonic disperser for 1 minute, and the particle size distribution of particles having a particle size in the range of 2 μm or more and 60 μm or less is measured with a Coulter Multisizer II using an aperture having an aperture diameter of 100 μm. The number of particles to be sampled is 50,000. The volume-based particle size distribution is drawn from the small diameter side, and the particle size at a cumulative percentage of 50% is defined as a volume-average particle size D50v.

The average circularity of the toner particles is preferably 0.94 or more and 1.00 or less, and more preferably 0.95 or more and 0.98 or less.

The average circularity of the toner particles is determined by (circle-equivalent circumference)/(circumference) [(circumference of a circle having the same projected area as that of the particle image)/(circumference of the particle projected image)]. Specifically, it is a value measured by the following method.

First, toner particles to be measured are collected by suction to form a flat flow, a particle image is captured as a still image by instantaneously emitting strobe light, and the particle image is analyzed by a flow-type particle image analyzer (FPIA-3000 manufactured by Sysmex Corporation). The number of samplings for obtaining the average circularity is set to 3,500.

In a case where the toner contains an external additive, the toner (developer) to be measured is dispersed in water containing a surfactant, and then subjected to ultrasonic treatment to obtain toner particles from which the external additive is removed.

—Method for Producing Toner Particles—

The toner particles may be produced by either of a dry production method (for example, a kneading and pulverizing method) and a wet production method (for example, an aggregation coalescence method, a suspension polymerization method, and a dissolution suspension method). The production method is not particularly limited, and a known production method is employed. Among these, toner particles are preferably obtained by an aggregation coalescence method.

Specifically, for example, in the case where toner particles are produced by an aggregation coalescence method, toner particles are produced through a step of preparing a resin particle dispersion liquid in which resin particles serving as a binder resin are dispersed (resin particle dispersion liquid preparation step), a step of aggregating resin particles (optionally other particles) in the resin particle dispersion liquid (optionally in a dispersion liquid obtained by mixing the resin particle dispersion liquid with another particle dispersion liquid) to form aggregated particles (aggregated particle formation step), and a step of heating the aggregated particle dispersion liquid in which the aggregated particles are dispersed to fuse and coalesce the aggregated particles, thereby forming toner particles (fusing and coalescing step).

Details of the Steps Will be Described Below.

Although the method described below is a method for producing toner particles containing a colorant and a release agent, the colorant and the release agent are optionally used. It should be understood that other additives other than the colorant and the release agent may be used.

—Resin Particle Dispersion Liquid Preparation Step—

A resin particle dispersion liquid in which resin particles serving as a binder resin are dispersed and, additionally, for example, a colorant particle dispersion liquid in which colorant particles are dispersed, and a release agent particle dispersion liquid in which release agent particles are dispersed are prepared.

The resin particle dispersion liquid is prepared, for example, by dispersing resin particles in a dispersion medium using a surfactant.

Examples of the dispersion medium used for the resin particle dispersion liquid include an aqueous medium.

Examples of the aqueous medium include water such as distilled water and ion exchange water, and alcohols. These may be used alone or in combination of two or more kinds thereof.

Examples of the surfactant include anionic surfactants such as sulfates, sulfonates, phosphates, and soaps; cationic surfactants such as amine salts and quaternary ammonium salts; and nonionic surfactants such as polyethylene glycols, alkylphenol ethyleneoxide adducts, and polyhydric alcohols. Among these, anionic surfactants and cationic surfactants are particularly preferable. The nonionic surfactant may be used in combination with an anionic surfactant or a cationic surfactant.

One kind of surfactant may be used singly, or two or more kinds of surfactants may be used in combination.

In the resin particle dispersion liquid, examples of a method for dispersing the resin particles in a dispersion medium include general dispersion methods using a rotary shearing homogenizer, a ball mill having media, a sand mill, a dyno mill, and the like. Depending on the type of the resin particles, the resin particles may be dispersed in the dispersion medium by a phase inversion emulsification method. The phase inversion emulsification method is a method in which a resin to be dispersed is dissolved in a hydrophobic organic solvent in which the resin is soluble, a base is added to an organic continuous phase (O phase) to neutralize the organic continuous phase, and then an aqueous medium (W phase) is added to perform phase inversion from W/O to O/W, whereby the resin is dispersed in the form of particles in the aqueous medium.

The volume-average particle size of the resin particles dispersed in the resin particle dispersion liquid is, for example, preferably 0.01 μm or more and 1 μm or less, more preferably 0.08 μm or more and 0.8 μm or less, and still more preferably 0.1 μm or more and 0.6 μm or less.

The volume-average particle size of the resin particles is measured by using a particle size distribution obtained by measurement with a laser diffraction particle size distribution analyzer (for example, LA-700 manufactured by HORIBA, Ltd.), drawing a cumulative distribution of volume from a small particle size side with respect to particle size ranges (channels) obtained by dividing the distribution, and setting a particle size at a cumulative percentage of 50% with respect to all particles as a volume-average particle size D50v. The volume-average particle size of the particles in other dispersion liquids is measured in the same manner.

The content of the resin particles contained in the resin particle dispersion liquid is preferably 5% by mass or more and 50% by mass or less, and more preferably 10% by mass or more and 40% by mass or less.

For example, a colorant particle dispersion liquid and a release agent particle dispersion liquid are also prepared in the same manner as in the resin particle dispersion liquid. That is, regarding the volume-average particle size of the particles, the dispersion medium, the dispersion method, and the content of the particles in the resin particle dispersion liquid, the same applies to the colorant particles dispersed in the colorant particle dispersion liquid and the release agent particles dispersed in the release agent particle dispersion liquid.

—Aggregated Particle Formation Step—

Next, the resin particle dispersion liquid, the colorant particle dispersion liquid, and the release agent particle dispersion liquid are mixed.

Then, the resin particles, the colorant particles, and the release agent particles are hetero-aggregated in the mixed dispersion liquid to form aggregated particles containing the resin particles, the colorant particles, and the release agent particles and having a diameter close to the diameter of target toner particles.

Specifically, for example, an aggregating agent is added to the mixed dispersion liquid, the pH of the mixed dispersion liquid is adjusted to be acidic (for example, pH 2 or more and 5 or less), a dispersion stabilizer is added as necessary, and then the mixed dispersion liquid is heated to a temperature close to the glass transition temperature of the resin particles (specifically, for example, not less than a temperature 30° C. lower than the glass transition temperature of the resin particles and no more than a temperature 10° C. lower than the glass transition temperature) to aggregate the particles dispersed in the mixed dispersion liquid, thereby forming aggregated particles.

In the aggregated particle formation step, for example, it is possible to add an aggregating agent to the mixed dispersion liquid at room temperature (for example, 25° C.) while stirring the mixed dispersion liquid with a rotary shearing homogenizer, adjust the pH of the mixed dispersion liquid to be acidic (for example, pH 2 or more and 5 or less), optionally add a dispersion stabilizer thereto, and then perform heating.

Examples of the aggregating agent include a surfactant having a polarity opposite to that of the surfactant contained in the mixed dispersion liquid, an inorganic metal salt, and a divalent or higher metal complex. When a metal complex is used as the aggregating agent, the amount of surfactant used is reduced and the charging characteristics are improved.

An additive which forms a complex or a similar bond with a metal ion of the aggregating agent may be used together with the aggregating agent, if necessary. As the additive, a chelating agent is suitably used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of the chelating agent added is preferably 0.01 parts by mass or more and 5.0 parts by mass or less, and more preferably 0.1 parts by mass or more and less than 3.0 parts by mass with respect to 100 parts by mass of the resin particles.

—Fusing and Coalescing Step—

Next, the aggregated particle dispersion liquid in which the aggregated particles are dispersed is heated, for example, to a temperature equal to or more than the glass transition temperature of the resin particles (for example, a temperature higher by 10° C. to 30° C. than the glass transition temperature of the resin particles) to fuse and coalesce the aggregated particles, thereby forming toner particles.

Toner Particles are Obtained Through the Above-Described Steps.

After an aggregated particle dispersion liquid in which aggregated particles are dispersed is obtained, the toner particles may be produced through a step of forming second aggregated particles by further mixing the aggregated particle dispersion liquid and a resin particle dispersion liquid in which resin particles are dispersed and aggregating the resin particles so that the resin particles are further attached to surfaces of the aggregated particles, and a step of forming toner particles having a core-shell structure by heating the second aggregated particle dispersion liquid in which the second aggregated particles are dispersed and fusing and coalescing the second aggregated particles.

After completion of the fusing and coalescing step, the toner particles formed in the solution are subjected to a washing step, a solid-liquid separation step, and a drying step, which are known, to obtain dried toner particles. In the washing step, it is preferable that displacement washing with ion exchange water is sufficiently performed from the viewpoint of chargeability. In the solid-liquid separation step, suction filtration, pressure filtration, or the like is preferably performed from the viewpoint of productivity. From the viewpoint of productivity, the drying step is preferably performed by freeze-drying, airflow drying, fluidized drying, vibration-type fluidized drying, or the like.

The toner according to the exemplary embodiment is produced, for example, by adding and mixing an external additive to the obtained dry toner particles. The external additive is preferably mixed using, for example, a V-blender, a Henschel mixer, or a Loedige mixer. If necessary, coarse particles of the toner may be removed using a vibration sifter, a wind sifter, or the like.

—External Additive—

Examples of the external additive include inorganic particles. Examples of the inorganic particles include SiO₂, TiO₂, Al₂O₃, CuO, ZnO, SNO₂, CeO₂, Fe₂O₃, MgO, BaO, CaO, K₂O, Na₂O, ZrO₂, CaO·SiO₂, K₂O·(TiO₂)N, Al₂O₃·2SiO₂, CaCO₃, MgCO₃, BaSO₄, and MgSO₄.

The surfaces of the inorganic particles serving as an external additive are preferably subjected to a hydrophobic treatment. The hydrophobic treatment is performed by, for example, immersing the inorganic particles in a hydrophobizing agent. Examples of the hydrophobizing agent include, but are not limited to, silane coupling agents, silicone oils, titanate coupling agents, and aluminum coupling agents. These hydrophobizing agents may be used alone or in combination of two or more kinds thereof.

The amount of the hydrophobizing agent is usually, for example, 1 part by mass or more and 10 parts by mass or less with respect to 100 parts by mass of the inorganic particles.

Other examples of the external additive include resin particles (for example, polystyrene, poly(methyl methacrylate), or melamine resin particles), and cleaning active agents (for example, metal salts of higher fatty acids, such as zinc stearate, and fluorinated polymer particles).

The amount of the external additive externally added is preferably 0.01% by mass or more and 5% by mass or less and more preferably 0.01% by mass or more and 2.0% by mass or less with respect to the toner particles.

<Image Forming Apparatus and Image Forming Method>

The image forming apparatus according to the exemplary embodiment includes an image holding member, a charging element that charges a surface of the image holding member, an electrostatic charge image forming element that forms an electrostatic charge image on the charged surface of the image carrier, a developing element that stores an electrostatic charge image developer and develops the electrostatic charge image formed on the surface of the image holding member, as a toner image with the electrostatic charge image developer, a transfer element that transfers the toner image formed on the surface of the image holding member, to a surface of a recording medium, and a fixing element that fixes the toner image transferred to the surface of the recording medium. As the electrostatic charge image developer, an electrostatic charge image developer containing a carrier for developing an electrostatic charge image produced by the method for producing a carrier for developing an electrostatic charge image according to the exemplary embodiment is applied.

The image forming apparatus according to the exemplary embodiment performs an image forming method (the image forming method according to the exemplary embodiment) including a charging step of charging a surface of an image carrier, an electrostatic charge image forming step of forming an electrostatic charge image on the charged surface of the image carrier, a developing step of developing the electrostatic charge image formed on the surface of the image carrier as a toner image with the electrostatic charge image developer according to the exemplary embodiment, a transfer step of transferring the toner image formed on the surface of the image carrier to a surface of a recording medium, and a fixing step of fixing the toner image transferred to the surface of the recording medium.

In the image forming method according to the exemplary embodiment, a carrier for developing an electrostatic charge image produced by the method for producing a carrier for developing an electrostatic charge image according to the exemplary embodiment is used.

As the image forming apparatus according to the exemplary embodiment, known image forming apparatuses such as the following are applied: a direct transfer type apparatus that directly transfers a toner image formed on a surface of an image holding member to a recording medium; an intermediate transfer type apparatus that primarily transfers a toner image formed on a surface of an image carrier to a surface of an intermediate transfer member and secondarily transfers the toner image transferred to the surface of the intermediate transfer member to a surface of a recording medium; an apparatus including a cleaning element that cleans the surface of the image holding member before charging after the transfer of the toner image; and an apparatus including a charge eliminating element that eliminates charge by irradiating the surface of the image holding member with charge eliminating light before charging after the transfer of the toner image.

When the image forming apparatus according to the exemplary embodiment is an intermediate transfer type apparatus, the transfer element includes, for example, an intermediate transfer member to the surface of which a toner image is transferred, a primary transfer element that primarily transfers the toner image formed on the surface of the image holding member to the surface of the intermediate transfer member, and a secondary transfer element that secondarily transfers the toner image transferred to the surface of the intermediate transfer member to the surface of a recording medium.

In the image forming apparatus according to the exemplary embodiment, for example, a portion including the developing element may have a cartridge structure (process cartridge) that is detachably attached to the image forming apparatus. As the process cartridge, for example, a process cartridge that accommodates the electrostatic charge image developer according to the exemplary embodiment and includes a developing element is suitably used.

An example of the image forming apparatus according to the exemplary embodiment is shown below, but the image forming apparatus is not limited thereto. In the following description, main portions shown in the drawings will be described, and the description of other portions will be omitted.

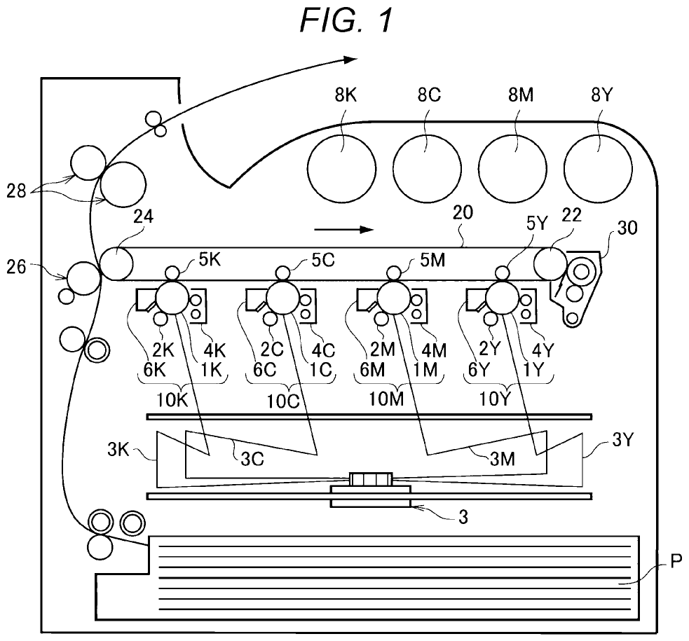

FIG. 1 is a schematic diagram illustrating an image forming apparatus according to the exemplary embodiment.

The image forming apparatus illustrated in FIG. 1 includes first to fourth electrophotographic image forming units 10Y, 10M, 10C, 10K (image forming elements) which output yellow (Y), magenta (M), cyan (C), and black (K) color images, respectively, on the basis of image data separately corresponding to these colors. These image forming units (hereinafter, may be simply referred to as “units”) 10Y, 10M, 10C, 10K are arranged side by side at a predetermined distance from each other in the horizontal direction. The units 10Y, 10M, 10C, 10K may be configured as a process cartridge detachably attached to the image forming apparatus.

Above the units 10Y, 10M, 10C, 10K, an intermediate transfer belt (an example of an intermediate transfer member) 20 is provided so as to extend over the units 10Y, 10M, 10C, 10K. The intermediate transfer belt 20 is wrapped around a driving roller 22 and a support roller 24 and travels in the direction from the first unit 10Y toward the fourth unit 10K. Force is applied to the support roller 24 with a spring or the like not shown in the drawing in the direction away from the driving roller 22 so that tension is applied to the intermediate transfer belt 20 stretched over the two rollers. An intermediate transfer member cleaning device 30 is provided on the image holding member side surface of the intermediate transfer belt 20 so as to face the driving roller 22.

Yellow, magenta, cyan, and black toners respectively contained in toner cartridges 8Y, 8M, 8C, 8K are respectively supplied to developing devices (an example of a developing element) 4Y, 4M, 4C, 4K of the respective units 10Y, 10M, 10C, 10K.

Since the first to fourth units 10Y, 10M, 10C, 10K have the same structure and operation, the first unit 10Y configured to form a yellow image and disposed on the upstream side in the intermediate transfer belt running direction is described as a representative example.

The first unit 10Y includes a photoreceptor 1Y as an image holding member. The photoreceptor 1Y is surrounded by, in sequence, a charging roller (an example of a charging element) 2Y that charges the surface of the photoreceptor 1Y to a predetermined potential, an exposure device (an example of an electrostatic charge image forming element) 3 that exposes the charged surface to a laser beam 3Y based on a color separation image signal to form an electrostatic charge image, a developing device (an example of a developing element) 4Y that supplies a charged toner to the electrostatic charge image to develop the electrostatic charge image, a primary transfer roller (an example of a primary transfer element) 5Y that transfers the developed toner image to the intermediate transfer belt 20, and a photoreceptor cleaning device (an example of a cleaning element) 6Y that removes residual toner from the surface of the photoreceptor 1Y after the primary transfer.

The primary transfer roller 5Y is disposed inside the intermediate transfer belt 20 and is provided at a position facing the photoreceptor 1Y. A bias power supply (not shown) that applies a primary transfer bias is connected to primary transfer rollers 5Y, 5M, 5C, 5K of the units. Each bias power supply changes the value of the transfer bias applied to each primary transfer roller under the control of a controller (not shown).

Operation of forming a yellow image by using the first unit 10Y will now be described.

Before the operation, the charging roller 2Y charges the surface of the photoreceptor 1Y to a potential of −600 V to −800 V.

The photoreceptor 1Y is formed by laminating a photosensitive layer on a conductive substrate (for example, having a volume resistivity of 1×10⁻⁶Ω cm or less at 20° C.). The photosensitive layer, which usually has high resistance (comparable to the resistances of common resins), has the property of changing its specific resistance in the region irradiated with a laser beam. The exposure device 3 emits the laser beam 3Y based on yellow image data received from the controller (not shown) toward the charged surface of the photoreceptor 1Y. As a result, an electrostatic charge image of a yellow image pattern is formed on the surface of the photoreceptor 1Y.

The electrostatic charge image refers to an image formed on the surface of the photoreceptor 1Y owing to charging and is a so-called negative latent image formed as follows: part of the photosensitive layer is irradiated with the laser beam 3Y to decrease the specific resistance thereof, and this causes a release of electric charges on the charged surface of the photoreceptor 1Y, whereas electric charges remain in another part not irradiated with the laser beam 3Y.

The electrostatic charge image formed on the photoreceptor 1Y is rotated to a predetermined developing position as the photoreceptor 1Y moves. At the developing position, the electrostatic charge image on the photoreceptor 1Y is developed and visualized as a toner image by the developing device 4Y.

In the developing device 4Y, for example, an electrostatic charge image developer containing at least a yellow toner and a carrier is accommodated. The yellow toner is frictionally charged as it is stirred in the developing device 4Y, and carried on a developer roll (an example of a developer-carrying member) while having charges having the same polarity (negative) as the charges on the photoreceptor 1Y As the surface of the photoreceptor 1Y passes by the developing device 4Y, the yellow toner electrostatically adheres on the latent image portion on the photoreceptor 1Y from which charges are eliminated, and the latent image is thereby developed with the yellow toner. The photoreceptor 1Y on which the yellow toner image is formed continues to rotate at a predetermined speed to transport the developed toner image on the photoreceptor 1Y to a predetermined primary transfer position.

When the yellow toner image on the photoreceptor 1Y is transported to the primary transfer position, a primary transfer bias is applied to the primary transfer roller 5Y, an electrostatic force from the photoreceptor 1Y toward the primary transfer roller 5Y acts on the toner image, and the toner image on the photoreceptor 1Y is transferred onto the intermediate transfer belt 20. The transfer bias applied then has the opposite polarity (positive) to that of the toner (negative) and is controlled to, for example, +10 μA in the first unit 10Y by the controller (not shown).

The photoreceptor cleaning device 6Y removes and collects residual toner from the photoreceptor 1Y.

The primary transfer biases applied to the primary transfer rollers 5M, 5C, 5K of the second to fourth units 10M, 10C, 10K are also controlled in the same manner.

Thus, the intermediate transfer belt 20 to which the yellow toner image is transferred at the first unit 10Y is sequentially transported through the second to fourth units 10M, 10C, 10K, and toner images of the respective colors are multi-transfered so that the toner images are superposed one on another.

The intermediate transfer belt 20 onto which the toner images of the four colors have been multi-transferred through the first to fourth units in a superimposed manner reaches a secondary transfer portion including the intermediate transfer belt 20, the support roller 24 that is in contact with the inner surface of the intermediate transfer belt 20, and a secondary transfer roller (an example of a secondary transfer element) 26 that is disposed on the image holding surface side of the intermediate transfer belt 20. Meanwhile, a recording sheet (an example of a recording medium) P is fed to a gap where the secondary transfer roller 26 and the intermediate transfer belt 20 are in contact with each other at a predetermined timing via a supply mechanism, and a secondary transfer bias is applied to the support roller 24. Because this transfer bias has the same polarity (negative) as that of the toner (negative), the toner image is transferred from the intermediate transfer belt 20 to the recording sheet P by an electrostatic force acting from the intermediate transfer belt 20 toward the recording sheet P. The secondary transfer bias applied then is determined in accordance with the resistance detected by a resistance detection element (not shown) that detects the resistance of the secondary transfer portion, and is controlled in voltage.

Thereafter, the recording sheet P is sent to a pressure contact portion (nip portion) between a pair of fixing rollers in a fixing device (an example of a fixing element) 28, and the toner image is fixed on the recording sheet P, so that a fixed image is formed.

Examples of the recording sheet P onto which the toner image is transferred include plain paper used in electrophotographic copying machines, printers, and the like. Examples of the recording medium include not only the recording sheet P but also an overhead projector (OHP) sheet.

In order to further improve the smoothness of the image surface after fixing, the surface of the recording sheet P is also preferably smooth, and for example, coated paper obtained by coating the surface of plain paper with a resin or the like, art paper for printing, or the like is suitably used.

The recording sheet P upon completion of the fixing of the color image is transported toward the discharging portion to terminate a series of color image forming operations.

<Process Cartridge>

A process cartridge according to an exemplary embodiment includes a developing element that accommodates the electrostatic charge image developer according to the exemplary embodiment and develops an electrostatic charge image formed on a surface of an image holding member as a toner image with the electrostatic charge image developer, and is detachably attached to an image forming apparatus.

The process cartridge according to the exemplary embodiment is not limited to the configuration described above, and may be configured to include a developing element and, if necessary, at least one selected from other elements such as an image holding member, a charging element, an electrostatic charge image forming element, and a transfer element.

An example of the process cartridge according to the exemplary embodiment is shown below, but the process cartridge is not limited thereto. In the following description, main portions shown in the drawings will be described, and the description of other portions will be omitted.

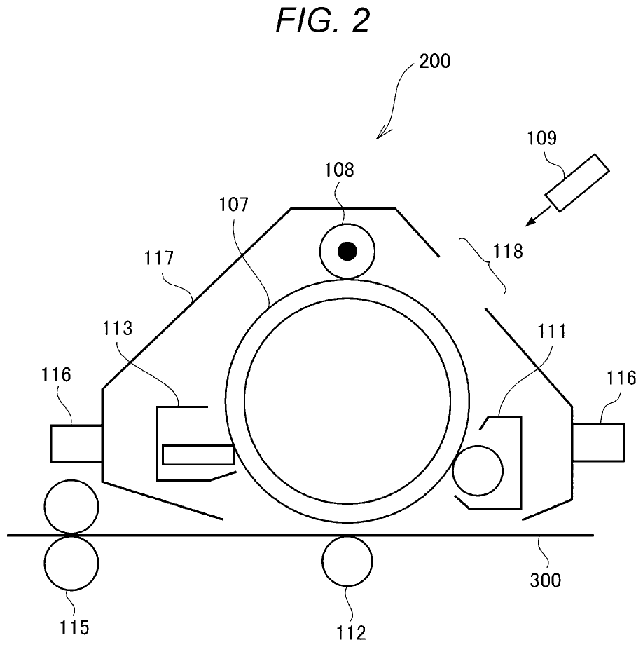

FIG. 2 is a schematic diagram illustrating the process cartridge according to the exemplary embodiment.

A process cartridge 200 illustrated in FIG. 2 is formed into a cartridge by, for example, integrally combining and holding a photoreceptor 107 (an example of an image holding member), a charging roller 108 (an example of a charging element) provided around the photoreceptor 107, a developing device 111 (an example of a developing element), and a photoreceptor cleaning device 113 (an example of a cleaning element) by a housing 117 having a mounting rail 116 and an opening 118 for exposure.

In FIG. 2, an exposure device (an example of an electrostatic charge image forming element) 109, a transfer device (an example of a transfer element) 112, a fixing device (an example of a fixing element) 115, and a recording sheet (an example of a recording medium) 300 are illustrated.

### Examples

Hereinafter, exemplary embodiments of the present invention will be described in detail with reference to examples, but the exemplary embodiments of the present invention are not limited to these examples. Unless particularly stated otherwise, the units “parts” and “percent (%)” are on a mass basis in the following description.

<Production of Toner>

—Preparation of Colorant Particle Dispersion Liquid—

Cyan pigment (copper phthalocyanine B15:3 (manufactured by Dainichiseika Color & Chemicals Mfg. Co., Ltd.)): 50 parts by mass

Anionic surfactant: NEOGEN SC (manufactured by DKS Co. Ltd.) 5 parts by mass

Ion exchange water: 200 parts by mass

The above-described components were mixed and dispersed with ULTRA-TURRAX (manufactured by IKA) for 5 minutes and further with an ultrasonic bath for 10 minutes to obtain a colorant particle dispersion liquid having a solid content of 21%. The volume-average particle size was measured with a particle size analyzer LA-700 (manufactured by HORIBA, Ltd.) and found to be 160 nm.

—Preparation of Release Agent Particle Dispersion Liquid—

Paraffin wax: HNP-9 (manufactured by NIPPON SEIRO CO., LTD.): 19 parts by mass

Anionic surfactant: NEOGEN SC (manufactured by DKS Co. Ltd.): 1 part by mass

Ion exchange water: 80 parts by mass

These components were mixed in a heat-resistant container and heated to 90° C., followed by stirring for 30 minutes. Next, the melt was allowed to flow from the bottom of the container to a Gaulin homogenizer, a circulation operation corresponding to 3 passes was performed under a pressure condition of 5 MPa, the pressure was increased to 35 MPa, and a circulation operation corresponding to 3 passes was further performed. The emulsion thus obtained was cooled to 40° C. or less in the heat-resistant container to obtain a release agent particle dispersion liquid. The volume-average particle size was measured with a particle size analyzer LA-700 (manufactured by HORIBA, Ltd.) and found to be 240 nm.

—Resin Particle Dispersion Liquid—

### [Oil Layer]

Styrene (manufactured by FUJIFILM Wako Pure Chemical Corporation): 30 parts by mass

N-butyl acrylate (manufactured by FUJIFILM Wako Pure Chemical Corporation): 10 parts by mass

β-Carboxyethyl acrylate (manufactured by Rhodia Nicca, Ltd.): 1.3 parts by mass

Dodecanethiol (manufactured by FUJIFILM Wako Pure Chemical Corporation): 0.4 parts by mass

### [Aqueous Layer 1]

Ion exchange water: 17 parts by mass

Anionic surfactant (DOWFAX, manufactured by The Dow Chemical Company): 0.4 parts by mass

### [Aqueous Layer 2]

Ion exchange water: 40 parts by mass

Anionic surfactant (DOWFAX, manufactured by The Dow Chemical Company): 0.05 parts by mass

Ammonium peroxodisulfate (manufactured by FUJIFILM Wako Pure Chemical Corporation): 0.4 parts by mass

The oil layer components and the components of the aqueous layer 1 were placed in a flask and mixed with stirring to prepare a monomer emulsion dispersion liquid. The components of the aqueous layer 2 were put into a reaction vessel, the inside of the reaction vessel was sufficiently purged with nitrogen, and the mixture was heated in an oil bath with stirring until the temperature of the reaction system reached 75° C. The monomer emulsion dispersion liquid was gradually added dropwise to the reaction vessel over 3 hours to carry out emulsion polymerization. After completion of the dropwise addition, the polymerization was further continued at 75° C., and the polymerization was terminated after 3 hours.

The volume-average particle size D50v of the obtained resin particles was measured using a laser diffraction particle size distribution analyzer LA-700 (manufactured by HORIBA, Ltd.) to be 250 nm; the glass transition temperature of the resin was measured using a differential scanning calorimeter (DSC-50, manufactured by Shimadzu Corporation) at a heating rate of 10° C./min to be 53° C.; and the number-average molecular weight (in terms of polystyrene) was measured using a molecular weight measuring device (HLC-8020, manufactured by Tosoh Corporation) and THE as a solvent to be 13,000. Thus, a resin particle dispersion liquid having a volume-average particle size of 250 nm, a solid content of 42%, a glass transition temperature of 52° C., and a number-average molecular weight Mn of 13,000 was obtained.

—Production of Toner 1—

Resin particle dispersion liquid: 150 parts by mass

Colorant particle dispersion liquid: 30 parts by mass

Release agent particle dispersion liquid: 40 parts by mass

Polyaluminum chloride: 0.4 parts by mass

The above components were thoroughly mixed and dispersed in a stainless steel flask using ULTRA-TURRAX manufactured by IKA, and then heated to 48° C. while the flask was stirred in a heating oil bath. After the mixture was kept at 48° C. for 80 minutes, 70 parts by mass of the same resin particle dispersion liquid as described above was gradually added thereto.

Thereafter, the pH in the system was adjusted to 6.0 using a sodium hydroxide aqueous solution having a concentration of 0.5 mol/L, the stainless steel flask was sealed, the seal of the stirring shaft was magnetically sealed, the components were heated to 97° C. while stirring was continued, and the components were held for 3 hours. After completion of the reaction, the mixture was cooled at a rate of temperature decrease of 1° C./min, filtered, sufficiently washed with ion exchange water, and subjected to solid-liquid separation by Nutsche suction filtration. This was further re-dispersed using 3,000 parts by mass of ion exchanged water at 40° C., and stirred and washed at 300 rpm for 15 minutes. This washing operation was further repeated 5 times, and when the pH of the filtrate reached 6.54 and the electrical conductivity reached 6.5 μS/cm, solid-liquid separation was performed by Nutsche suction filtration using No. 5A filter paper. Then, vacuum drying was continued for 12 hours to obtain toner particles.

The volume-average particle size D50v of the toner particles measured with a Coulter counter was 6.2 μm, and the volume-average particle size distribution index GSDv was 1.20. The shape was observed with a LUZEX image analyzer (manufactured by Nireco Corporation), and it was observed that the particles had a potato shape with a shape factor SF1 of 135. The glass transition temperature of the toner was 52° C. Further, silica (SiO₂) particles having an average primary particle size of 40 nm and surface-hydrophobized with hexamethyldisilazane (hereinafter sometimes abbreviated as “HMDS”) and metatitanic acid compound particles having an average primary particle size of 20 nm and formed of a reaction product of metatitanic acid and isobutyltrimethoxysilane were added to the toner so that the coverage of the surfaces of the toner particles was 40%, and the mixture was mixed with a Henschel mixer to produce a toner 1.

### [Preparation of Coating Liquid 1]

Lacquer (a solution obtained by mixing 20 parts of a cyclohexyl methacrylate/methyl methacrylate copolymer (copolymerization ratio: 95 mol %/5 mol %) (weight-average molecular weight: 65,000, glass transition temperature: 105° C.) and 80 parts of toluene): 100 parts

Carbon black (average particle size: 0.2 μm): 0.22 parts with respect to 100 parts of the magnetic particles

A disperser (sand mill) was filled with glass beads having a diameter of ϕ1 mm, and the above-described materials were put thereinto and dispersed at a circumferential speed of a disc of 10 m/s for 30 minutes, thereby obtaining a coating liquid 1.

### Example 1

### —First Step (Mixing Step)—

Ferrite particles (volume-average particle size: 35 μm): 100 parts

Coating liquid 1: an amount such that the solid content is 3 parts with respect to 100 parts of the ferrite particles

Into a batch stirring type vacuum mixer (50 L kneader manufactured by INOUE MFG., INC., stirring blade diameter D=0.25 μm, clearance between casing inner wall and outer periphery of stirring blade/D=3.5%) warmed to a jacket temperature of 90° C., 50 kg of the above components were put, and stirred and mixed at 60 rpm with the internal pressure of the mixer of 80 kPa-abs until the temperature in the tank reached 70° C.

The relationship between the rotation speed N1 (rps) of the stirring blade, the diameter D of the stirring blade, and the time t1 (s) of the first step, that is, “the circumferential speed of the stirring blade (πDN1)×t1 (πDN1)×the viscosity μ of the dispersion liquid” in the first step, the pressure in the mixer, and the temperature reached by the mixture at the start of drying were adjusted to the values shown in Table 1.

The “temperature of the mixture” described in Table 1 indicates the temperature in the tank at the start of the second step.

—Second Step (Drying Step)—

Then, the internal pressure of the mixer was reduced to 10 kPa-abs in 5 minutes and fixed at 10 kPa-abs at 60 rpm until the solvent was dried. Cold water at 20° C. was injected into the jacket of the mixer at the timing when the stirring power in the mixer decreased to 1.3 times the stirring power value before the start of drying.

—Third Step (Cooling Step)—

After 45 minutes at 60 rpm from the time when cold water at 20° C. was injected into the mixer (=the end point of the second step), stirring was stopped, and the mixture was discharged from the mixer into a container to produce a carrier.

—Fourth Step (Coarse Powder Removing Step)—

The carrier extracted from the mixer was sieved through a 75 μm sieve to produce a carrier 1.

### Examples 2 to 10

Carriers 2 to 10 as carriers of Examples 2 to 10 were produced in the same manner as in Example 1, except that some change has been made so that the conditions described in Table 1 were satisfied.

### Example 11

### [Preparation of Coating Liquid 2]

A carrier 11 was produced under the conditions shown in Table 1, except that a lacquer; a styrene/methyl methacrylate copolymer (copolymerization ratio: 30% by mass/70% by mass) was used.

### Example 12

A carrier 12 was produced under the conditions shown in Table 1, except that 100 parts of ferrite particles (volume-average particle size: 25 μm) were used.

### Comparative Example 1

### [Preparation of Coating Liquid C1]

Lacquer (a solution obtained by mixing 5 parts of a cyclohexyl methacrylate/methyl methacrylate copolymer (copolymerization ratio 95 mol:5 mol) (weight-average molecular weight:65,000, glass transition temperature:105° C.) and 95 parts of toluene):100 parts

Carbon black (average particle size: 0.2 μm): 0.6 parts with respect to 100 parts of the coating liquid C1

A disperser (sand mill) was filled with glass beads having a diameter of ϕ1 mm, and the above-described materials were put thereinto and dispersed at a circumferential speed of a disc of 10 m/s for 30 minutes, thereby obtaining a coating liquid C1.

A carrier C1 of Comparative Example 1 was produced in the same manner as in Example 1, except that the coating liquid 1 was changed to the coating liquid C1 in Table 1.

### Comparative Examples 2 to 4

Carriers C2 to C4 as carriers of Comparative Examples 2 to 4 were produced in the same manner as in Example 1, except that the conditions described in Table 1 were satisfied.

<Production of Developer>

Any one of the carriers 1 to 12 and C1 to C4 and the toner 1 were placed in a V-blender at a mixing ratio of carrier:toner=100:10 (mass ratio) and stirred for 20 minutes to obtain developers 1 to 12 and C1 to C4, respectively.

—Measurement of Viscosity μ of Coating Liquid—

The viscosity μ(mPa·s) at the temperature of the coating liquid at the time of addition in the first step (mixing step) was measured using a vibration viscosimeter (VISCOMATE VM-10A, manufactured by SEKONIC CORPORATION).

—Measurement of Coverage with Resin Coating Layer in Carrier—

The coverage with the resin coating layer on the surface of the carrier was determined by X-ray photoelectron spectroscopy (XPS) by the following method.

A target carrier and magnetic particles obtained by removing a resin coating layer from the target carrier are prepared. As a method of removing the resin coating layer from the carrier, a method of dissolving the resin component with toluene to remove the resin coating layer was used. The carrier and the magnetic particles from which the resin coating layer had been removed were used as measurement samples, Fe, C, and O (atomic %) were quantified by XPS, (Fe of carrier)/(Fe of magnetic particles)×100 was calculated, an exposure rate (%) of the magnetic particles was obtained, and (100−exposure rate of magnetic particles) was defined as a coverage (%) with the resin coating layer.

—Measurement of Amount of Free Resin in Carrier—

A certain amount of the carrier was weighed and dispersed in water, and the dispersion liquid was filtered with the carrier being fixed with a magnet. The filter paper was dried, and the amount of free resin was calculated from the mass difference before and after the filtration and the amount of the weighed carrier.

—Evaluation of Color Dullness Suppressing Property—

The color dullness was evaluated in the following manner.

DocuColor 7171 P (manufactured by FUJIFILM Business Innovation Co., Ltd.) filled with the obtained developer was used to output one sheet of a patch of a solid image of 5 cm×5 cm (sample 1), subsequently output 100,000 sheets of an image having an area coverage of 5%, and then output one sheet of a patch of a solid image of 5 cm×5 cm again (sample 2). Then, the color gamut (L*, a*, b*) of the sample 1 and the sample 2 was measured. The color gamut was measured with an image densitometer X-RITE 938 (manufactured by X-Rite Inc.).

ΔE was calculated from the difference between the color gamut of the sample 2 and the color gamut of the sample 1 using the following equation, and was used as an index for the evaluation of color dullness.

ΔE=[(ΔL*)²+(Δa*)²+(Δb*)²]^{1/2}

In the equation, ΔL*=(L* of sample 2−L* of sample 1), Δa*=(a* of sample 2−a* of sample 1), and Δb*=(b* of sample 2−b* of sample 1).

The criteria for evaluation were as follows. The evaluation result is preferably G1 or G2, and is more preferably G1. —Criteria for Evaluation—

G1:ΔE≤3.0

G2:3.0<ΔE≤6.0

G3:6.0<ΔE≤10

G4:10≤ΔE

The evaluation results are collectively listed in Table 1.

TABLE 1

| | | Coating liquid | | | | | | | | | |
|---|---|---|---|---|---|---|---|---|---|---|---|
| | | | | | Content | | | | | | |
| | | | | | of carbon | | | | | | |
| | | | | | black with | | | | | | |
| | | | | | respect | | | | | | |
| | | | | | to 100 | | | Carrier | | | |
| | | | | | parts by | | | | Amount | | |
| | | | | | mass of | | | Average | W of resin | | |
| | | | Particle | Content | coating | | | particle | coating | Content of | |
| | | | size of | of resin | liquid | Solid content | | size of | layer* | carbon black* | |
| | Type of | Resin | carbon black | (% by | (parts | concentration | Viscosity μ | carrier | (parts | (parts | |
| | carrier | type | (μm) | mass) | by mass) | (% by mass) | (mPa %) | (μm) | by mass) | by mass) | μW |
| Example 1 | 1 | A | 0.2 | 20 | 2.2 | 21.7 | 118 | 35 | 3.0 | 0.3 | 39 |
| Example 2 | 2 | A | 0.2 | 25 | 2.7 | 26.4 | 298 | 35 | 3.0 | 0.3 | 99 |
| Example 3 | 3 | A | 0.2 | 20 | 2.2 | 21.7 | 118 | 35 | 1.5 | 0.3 | 79 |
| Example 4 | 4 | A | 0.2 | 15 | 1.6 | 16.4 | 65 | 35 | 3.0 | 0.3 | 22 |
| Example 5 | 5 | A | 0.2 | 20 | 2.2 | 21.7 | 118 | 35 | 3.0 | 0.3 | 39 |
| Example 6 | 6 | A | 0.2 | 20 | 2.2 | 21.7 | 118 | 35 | 3.0 | 0.3 | 39 |
| Example 7 | 7 | A | 0.2 | 20 | 2.2 | 21.7 | 118 | 35 | 3.0 | 0.3 | 39 |
| Example 8 | 8 | A | 0.2 | 20 | 2.2 | 21.7 | 118 | 35 | 3.0 | 0.3 | 39 |
| Example 9 | 9 | A | 0.2 | 20 | 3.9 | 23.1 | 456 | 35 | 3.0 | 0.5 | 152 |
| Example 10 | 10 | A | 0.2 | 10 | 4.2 | 23.1 | 530 | 35 | 1.2 | 0.9 | 442 |
| Example 11 | 11 | B | 0.2 | 20 | 1.4 | 21.7 | 185 | 35 | 3.0 | 0.3 | 62 |
| Example 12 | 13 | A | 0.2 | 20 | 2.2 | 21.7 | 118 | 25 | 3.0 | 0.3 | 39 |
| Comparative | 14 | A | 0.2 | 10 | 0.6 | 5.5 | 10 | 35 | 3.0 | 0.30 | 3.3 |
| Example 1 | | | | | | | | | | | |
| Comparative | 15 | A | 0.2 | 35 | 0.6 | 5.5 | 1,050 | 35 | 1.0 | 0.30 | 1,050 |
| Example 2 | | | | | | | | | | | |
| Comparative | 16 | A | 0.2 | 15 | 0.2 | 21.7 | 55 | 35 | 5.0 | 0.22 | 11 |
| Example 3 | | | | | | | | | | | |
| Comparative | 17 | A | 0.2 | 20 | 11.3 | 28 | 650 | 35 | 1.0 | 1.17 | 650 |
| Example 4 | | | | | | | | | | | |

Characteristics of carrier

| | | | | | | | | Amount of | | | |
|---|---|---|---|---|---|---|---|---|---|---|---|
| | | | | | | | | coating | | | |
| | | | | | | | | resin with | | | |
| | Mixing conditions | | | | | | | respect to | | | |
| | Rotation | | | | | | | 100 parts | Coverage | | Evaluation |
| | speed n of | | | | | Temperature | | by mass | with resins | | Color |
| | stirring | Stirring | | Amount | Pressure | reached | μ × | of carrier | coating | Amount of | dullness |
| | blade | time T | Circumferential | of work | in mixer | in mixer | amount | (parts | layer | free resin | suppressing |
| | (rpm) | (min) | speed (m/s) | (m) | (kPa-s) | (° C.) | of work | by mass) | (%) | (ppm) | property |
| Example 1 | 60 | 20 | 0.79 | 942 | 80 | 70 | 1.1E+05 | 2.95 | 91 | 46 | G1 |
| Example 2 | 60 | 20 | 0.79 | 942 | 80 | 70 | 2.8E+05 | 2.98 | 94 | 18 | G1 |
| Example 3 | 10 | 20 | 0.13 | 157 | 80 | 70 | 1.9E+04 | 1.45 | 86 | 65 | G1 |
| Example 4 | 60 | 20 | 0.79 | 942 | 80 | 70 | 6.1E+04 | 3.87 | 96 | 20 | G2 |
| Example 5 | 60 | 5 | 0.79 | 236 | 80 | 70 | 2.8E+04 | 2.95 | 91 | 46 | G1 |
| Example 6 | 60 | 60 | 0.79 | 2,827 | 80 | 70 | 3.3E+05 | 2.95 | 91 | 18 | G1 |
| Example 7 | 60 | 20 | 0.79 | 942 | 80 | 65 | 1.1E+05 | 2.98 | 90 | 46 | G1 |
| Example 8 | 60 | 20 | 0.79 | 942 | 95 | 80 | 1.1E+05 | 2.94 | 93 | 41 | G1 |
| Example 9 | 60 | 20 | 0.79 | 942 | 80 | 70 | 4.3E+05 | 2.95 | 91 | 98 | G2 |
| Example 10 | 60 | 20 | 0.79 | 942 | 80 | 70 | 5.0E+05 | 0.98 | 90 | 105 | G2 |
| Example 11 | 50 | 20 | 0.79 | 942 | 95 | 85 | 1.7E+05 | 2.95 | 90 | 63 | G1 |
| Example 12 | 60 | 20 | 0.79 | 942 | 80 | 70 | 1.1E+05 | 2.95 | 88 | 156 | G2 |
| Comparative | 60 | 20 | 0.79 | 942 | 80 | 70 | 9.4E+03 | 2.98 | 98 | 520 | G4 |
| Example 1 | | | | | | | | | | | |
| Comparative | 60 | 20 | 0.79 | 942 | 80 | 70 | 9.9E+05 | 0.89 | 85 | 456 | G4 |
| Example 2 | | | | | | | | | | | |
| Comparative | 60 | 20 | 0.79 | 942 | 80 | 70 | 5.2E+04 | 2.95 | 91 | 320 | G3 |
| Example 3 | | | | | | | | | | | |
| Comparative | 60 | 20 | 0.79 | 942 | 80 | 70 | 6.1E+05 | 0.75 | 65 | 786 | G4 |
| Example 4 | | | | | | | | | | | |

* in Table 1 and A and B in the column of resin type represent the following.
*amount with respect to 100 parts by mass of the magnetic particles
Material type A: Cyclohexyl methacrylate/methyl methacrylate copolymer (copolymerization ratio: 95 mol %/5 mol %)
Material type B: Styrene/methyl methacrylate copolymer (copolymerization ratio: 30% by mass/70% by mass)

Further, the description of “E+0n” (n=3, 4, or 5) in the column of “μ×amount of work” in Table 1 represents “×10ⁿ”. That is, the description of “1.1 E+05” in the column of “μ×amount of work” of Example 1 represents “1.1×10⁵”.

From the above results, it can be seen that Examples are superior to Comparative Examples in terms of the color dullness suppressing property of an image to be obtained.

What is claimed is:

1. A method for producing a carrier for developing an electrostatic charge image, the method comprising:
mixing in a mixer a coating liquid that contains a resin, conductive particles, and a solvent, and magnetic particles to obtain a mixture thereof, the mixer having a stirring blade; and
drying the solvent from the mixture by evaporation in order to produce a carrier having a resin coating layer on surfaces of the magnetic particles, wherein
a viscosity μ of the coating liquid when being added to the mixer is more than 60 mPa·s and 1,000 mPa·s or less, and
a value of a ratio μ/W of the viscosity μ(mPa·s) to an amount W (parts by mass) of the resin coating layer with respect to 100 parts by mass of the magnetic particles in the carrier is 20 or more and 500 or less.

2. The method for producing a carrier for developing an electrostatic charge image according to claim 1, wherein the amount W of the resin coating layer is 1 part by mass or more and 5 parts by mass or less with respect to 100 parts by mass of the magnetic particles.

3. The method for producing a carrier for developing an electrostatic charge image according to claim 2, wherein the amount W of the resin coating layer is 2 parts by mass or more and 4 parts by mass or less with respect to 100 parts by mass of the magnetic particles.

4. The method for producing a carrier for developing an electrostatic charge image according to claim 1, wherein the viscosity μ is 80 mPa·s or more and 800 mPa·s or less.

5. The method for producing a carrier for developing an electrostatic charge image according to claim 4, wherein the viscosity μ is 100 mPa·s or more and 500 mPa·s or less.

6. The method for producing a carrier for developing an electrostatic charge image according to claim 1, wherein the value of μ/W is 30 or more and 150 or less.

7. The method for producing a carrier for developing an electrostatic charge image according to claim 1, wherein a solid content concentration S of the mixture excluding the magnetic particles is 10% by mass or more and 30% by mass or less.

8. The method for producing a carrier for developing an electrostatic charge image according to claim 1, wherein stirring conditions in the mixing satisfy Expression 1:
1×10⁴≤amount of stirring work(=circumferential speedπDN×stirring time T)×viscosityμ(mPa·s)≤5×10⁵ (Expression 1),
wherein D represents a diameter (μm) of the stirring blade, N represents a rotation speed (rps) of the stirring blade, and T represents a stirring time (s) from the addition of the coating liquid to start of evaporation and drying of the solvent.

9. The method for producing a carrier for developing an electrostatic charge image according to claim 1, wherein a temperature in the mixer in the mixing is not less than a temperature 50° C. lower than a boiling point of the solvent and not more than a temperature 20° C. lower than the boiling point of the solvent depending on a pressure in the mixer.

10. The method for producing a carrier for developing an electrostatic charge image according to claim 1, wherein an amount of the conductive particles added in the mixing is 0.1 parts by mass or more and 1.0 part by mass or less with respect to 100 parts by mass of the magnetic particles.

11. An electrostatic charge image developer comprising:
a carrier for developing an electrostatic charge image produced by the method for producing a carrier for developing an electrostatic charge image according to claim 1; and
a toner for developing an electrostatic charge image.

12. An image forming method comprising at least:
charging an image holding member;
exposing the charged image holding member to form an electrostatic latent image on a surface of the image holding member;
developing the electrostatic latent image formed on the surface of the image holding member with an electrostatic charge image developer to form a toner image;
transferring the toner image formed on the surface of the image holding member to a surface of a transfer medium; and
fixing the toner image, wherein
the electrostatic charge image developer is the electrostatic charge image developer according to claim 11.

13. An image forming apparatus comprising:
an image holding member;
a charging element that charges the image holding member;
an exposure element that exposes the charged image holding member to light to form an electrostatic latent image on the image holding member;
a developing element that develops the electrostatic latent image with an electrostatic charge image developer to form a toner image;
a transfer element that transfers the toner image from the image holding member to a transfer medium; and
a fixing element that fixes the toner image, wherein
the electrostatic charge image developer is the electrostatic charge image developer according to claim 11.
